(19) United States
(12) Patent Application Publication
(10) Pub. No.: US 2004/0091688 A1
(43) Pub. Date: May 13, 2004

(54) Heat-resistant film base-material-inserted B-staged resin composition sheet excellent in adhesion to resin, multilayer board using the sheet and manufacturing process of the multilayer board

(76) Inventors: Morio Gaku, Tokyo (JP); Nobuyuki Ikeguchi, Tokyo (JP); Takabumi Omori, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/703,488

(22) Filed: Nov. 10, 2003

(30) Foreign Application Priority Data
Nov. 11, 2002 (JP) 326667/2002
Jul. 10, 2003 (JP) 272996/2003
Jul. 24, 2003 (JP) 278947/2003
Mar. 26, 2003 (JP) 84556/2003
Oct. 9, 2003 (JP) 350779/2003

(51) Int. Cl. B32B 3/00; B31B 1/60

(52) U.S. Cl. 428/209; 156/60

(57) ABSTRACT

A heat-resistant film base-material-inserted B-staged resin composition sheet obtainable by adhering a layer of a B-staged resin composition to a heat-resistant film base material, wherein the heat-resistant film base material is plasma-treated before adhering the B-staged resin composition layer, a multilayer board using the above heat-resistant film base-material-inserted B-staged resin composition sheet in a buildup layer and/or a bonding layer, and a manufacturing process of the multilayer board.

### FIELD OF THE INVENTION

The present invention relates to a heat-resistant film base-material-inserted B-staged resin composition sheet for a multilayer printed wiring board, a multilayer board using the above B-staged resin composition sheet and a manufacturing process of the above multilayer board. More specifically, it relates to a heat-resistant film base-material-inserted B-staged resin composition sheet for a multilayer printed wiring board, which is used as an adhesive sheet for producing a multilayer printed wiring board by laminating a conductor circuit and an interlayer resin insulating layer on a substrate sequentially according to the subtractive process or (semi)additive process or as an adhesive sheet for producing a multilayer board by being used like general glass-fabric base materials which are disposed between internal boards and on an external layer and integrated by laminate-molding, a multilayer board using the above sheet and a manufacturing process of the above multilayer board.

A high-density multilayer printed wiring board excellent in copper adhesive strength, heat resistance and reliability can be produced by using the above B-staged resin composition sheet. The obtained multilayer printed wiring board, as a high-density small printed wiring board, has a semiconductor chip mounted thereon and is used mainly for a small-sized and lightweight novel CSP and for a semiconductor plastic package.

### PRIOR ARTS OF THE INVENTION

In recent years, a high-density multilayer printed wiringboard is used in electronic equipment that is increasingly decreasing in size, thickness and weight. As a B-staged resin composition sheet used for the above multilayer printed wiring board, JP-A-8-231940 and JP-A-2000-17148 disclose adhesive sheets in which a B-staged resin composition layer for a (semi)additive process, obtained by incorporating a large amount of rubber into an epoxy resin, adheres to a release film such as a polyester film or a metal foil. However, these adhesive sheets are poor in reliability such as migration resistance in Z direction and also poor in electric characteristics and heat resistance when an insulating layer thickness is small, so that there is a limitation in using these adhesive sheets for a multilayer printed wiring board.

Further, when a printed wiring board is obtained by using adhesive sheets for a semi-additive process which are not reinforced with a base material and are made only of a resin layer, as disclosed in JP-A-5-86204 and JP-5-267840, on both surfaces of a thin internal layer board and carrying out buildup to form a multilayer board, the printed wiring board is poor in mechanical strength such as bending strength or tensile strength and elastic modulus (stiffness) and warping is apt to occur, which causes defectives in a step such as assembly step. Further, when a B-staged resin composition sheet obtained by adhering a resin layer to a non-treated surface of a heat-resistant film base material is used to prepare a multilayer board, the multilayer board swells when heat-treated after absorbing even a small amount of moisture.

A method of producing a multilayer board using a prepreg obtained by impregnating a glass fabric with a thermosetting resin composition and drying it is a general method. However, when a glass woven fabric or non-woven fabric having a thickness of 30 μm is used, the resin composition is adhered in a large amount for filling of an internal copper foil. For this reason, an insulating layer thickness after molding becomes 30 to 40 μm, and it is difficult to further decrease the above thickness. When molding is carried out so as to decrease the insulating layer thickness to the thickness of the glass base material, a glass fiber becomes in contact with an internal copper foil, so that reliability such as migration resistance or heat resistance after moisture absorption is poor. In addition, when a base material such as a glass fabric is used, it is required to carry out laminate-molding by a batch method with applying a pressure to the last for preventing the occurrence of defects caused by adherence of bubbles to the base material part. This method uses a multistage press and, generally, only one sheet can be laminate-molded for each stage. Further, the period of time to raise the temperature of hot plate of the press and the period of time to cool the hot plate at a finish time are long so that there is a problem in mass-productivity. Concerning molding conditions of a resin-adhered copper foil, many publications such as JP-A-2001-177241 disclose them.

### SUMMARY OF THE INVENTION

It is an object of the present invention to provide a heat-resistant film base-material-inserted B-staged resin composition sheet used for producing a high-density multilayer printed wiring board which is high in mechanical strength such as elastic modulus, excellent in thickness accuracy after laminate-molding and heat resistance after moisture absorption and also excellent in reliability, a multilayer board using the above B-staged resin composition sheet and a manufacturing process of the above multilayer board.

It is another object of the present invention to provide a manufacturing process of a multilayer board which process, when the above heat-resistant film base-material-inserted B-staged resin composition sheet is used for lamination of a multilayer printed wiring board, makes it possible to adhere the above B-staged resin composition sheet in a short time without any bubbles, can carry out post-curing at a time, can shorten the period of time to be required for molding, and is excellent in mass-productivity.

According to the present invention, there is provided a heat-resistant film base-material-inserted B-staged resin composition sheet obtainable by adhering a layer of a B-staged resin composition to a heat-resistant film base material, wherein the heat-resistant film base material is plasma-treated before adhering the B-staged resin composition layer.

According to the present invention, further, there is provided a sheet according the above, wherein the resin composition of the B-staged resin composition sheet is a thermosetting resin composition whose glass transition temperature after curing is at least 180° C.

According to the present invention, further, there is provided a sheet according the above, wherein the heat-resistant film is preliminarily surface-treated by physical treatment other than the plasma treatment before the plasma treatment.

According to the present invention, further, there is provided a manufacturing process of a multilayer board, which process comprising preparing a disposition material in which the heat-resistant film base-material-inserted B-staged resin composition sheet(s) recited in claim 1 is/are disposed on or on and between conductor circuit substrate(s) and a metal foil is contained as an outermost layer, bonding the above components of the disposition material to each other with a flat and smooth heating plate under pressure to carry out semi-curing and then heating it in a heating furnace to carry out curing.

### BRIEF DESCRIPTION OF THE DRAWINGS

FIG. 1 is an explanatory drawing showing a contact angle measurement method.

### DETAILED DESCRIPTION OF THE INVENTION

The heat-resistant film base-material-inserted B-staged resin composition sheet of the present invention is used as an adhesive sheet for producing a multilayer printed wiring board by laminating a conductor circuit and an interlayer resin insulating layer on a substrate sequentially according to the subtractive process or (semi)additive process or as an adhesive sheet for producing a multilayer board by being used like general glass-fabric base prepregs which are disposed between internal boards and on an external layer and integrated by laminate-molding. The heat-resistant film base-material-inserted B-staged resin composition sheet of the present invention is obtained by treating a surface of a heat-resistant film with plasma and then forming a B-staged resin composition layer on at least one surface of the heat-resistant film. The obtained heat-resistant film base-material-inserted B-staged resin composition sheet is used as an adhesive sheet for a multilayer printed wiring board.

The heat-resistant film base-material-inserted B-staged resin composition sheet may have a metal foil adhered to one surface thereof. The above resin composition sheet with the metal foil can be suitably used as an adhesive sheet for buildup or the like. The resin compositions to be adhered to both surfaces of the heat-resistant film are not specially limited and are selected depending upon purposes as required. For example, the above B-staged resin composition sheet may have a structure in which an insulating layer for the (semi)additive process is formed on one surface and a known resin composition layer for lamination is formed on the other surface or a structure in which resin composition layers for lamination are formed on both surfaces.

The above heat-resistant film base-material-inserted B-staged resin composition sheet contains the heat-resistant film base material, so that a printed wiring board obtained by carrying out buildup using a particularly thin internal layer board is high in mechanical strength and small in warp and distortion as compared with a printed wiring board using a conventional B-staged resin composition sheet having no base material. Since the heat-resistant film base-material-inserted B-staged resin composition sheet has the above characteristics, it is excellent in molding thickness at the time of lamination and suitable for a thin-type high-density printed wiring board produced by the subtractive process or (semi)additive process. Further, since the heat-resistant film interrupts the Z direction, the above printed wiring board is high in insulating reliability in the Z direction, and it is very excellent in migration resistance.

The use of the heat-resistant film gives large characteristic improvements in warp and distortion. However, a need for a further improvement in adhesive strength between the heat-resistant film and the resin was found. As a result of studies on a surface treatment of the heat-resistant film, the following has been found. When the surface of the heat-resistant film is plasma-treated, fine roughness is formed on the surface of the film and the heat-resistant film and the resin are bonded more strongly. As a result thereof, heat resistance after moisture absorption is largely increased.

Further, although the use of the heat-resistant film can make large improvements in properties, studies on a surface treatment of the heat-resistant film were carried out for a further improvement in the adhesive strength between the heat-resistant film and the resin. As a result thereof, the following has been found. A plasma surface treatment of the film is usually carried out at a normal pressure in many cases. However, when the surface of the heat-resistant film is treated with a low-pressure plasma and the surface treatment is carried out at 10 to 80 W·sec/cm² which is lager than a generally-used treatment electric power density, the heat-resistant film and the resin are bonded more strongly even at a high temperature. As a result thereof, heat resistance after moisture absorption is largely increased.

Furthermore, concerning sheets in which a B-staged resin composition layer adheres to a heat-resistant film, generally, the resin contains a large amount of a flexible component such as a rubber component for imparting flexibility in many cases. These sheets are generally low in the heat resistance of the B-staged resin composition layer. Further, there are sheets using a resin excellent in heat resistance, such as polyimide, in an adhesive layer, while these sheets are generally molded at a high temperature, so that there is a defect that a material low in heat resistance such as general FR-4 cannot be used. Under these circumstances, the present inventors have made studies on the B-staged resin composition layer to be adhered to the heat resistant film and, as a result, found the following. By adhering a thermosetting resin composition having a glass transition temperature, after curing, of at least 180° C., molding can be carried out at the same temperature as that of a general curing condition of a laminate and the heat-resistant film and the resin are bonded more strongly even at a high temperature, so that heat resistance after moisture absorption is largely increased.

The plasma treatment can be selected from general plasma treatment methods and productivity is high. Further, the degree of roughness of the heat-resistant film can be freely controlled by plasma treatment conditions depending upon purposes. Moreover, the treatment with plasma can give finer roughness than a treatment with a chemical and thus has an advantage in that the adhesive strength is high.

The heat-resistant film base material of the present invention is plasma-treated before adhering the resin composition. The heat-resistant film base material is not specially limited in kind and thickness and can be selected from known ones. Specifically, it includes a polyimide film, a polyparabanic acid film, a liquid crystalline polyester film and a wholly aromatic polyamide film. The thickness is selected depending upon purposes as required. A wholly aromatic polyamide film having a low thermal expansion coefficient is preferably used. A heat-resistant film having a thickness of 4 to 12 μm is preferably used for obtaining a small insulating layer thickness, after laminate-molding, of about 15 to 30 μm.

Before the adhesive resin layer is formed on the heat-resistant film surface, the heat-resistant film surface is plasma-treated to form fine roughness on the surface and activate the surface at the same time.

The plasma treatment can be selected from known ones, while a low-pressure plasma is preferably used. The plasma treatment is carried out at 100 watt or higher, preferably 500 watt or higher. The treatment time is not specially limited, while the treatment time is at least several seconds, preferably at least 1 minute, more preferably at least 5 minutes. The above condition is properly selected depending upon the size of a watt used and an electrode used, while it is not specially limited. The contact angle of a film surface with water is listed as a judgment means for the treatment. The water contact angle after the treatment is generally 50 degree or lower, preferably 25 degree of lower. When the heat-resistant film is allowed to stand in air after the plasma treatment, the water contact angle increases. However, it is preferred that the plasma-treated heat-resistant film has a water contact angle of 50 degree or lower, preferably 25 degree of lower.

The present invention adopts the low-pressure plasma treatment as a particularly preferred plasma treatment method.

A gas used for the low-pressure plasma treatment includes known gases such as helium, argon, krypton, xenon, neon, radon, nitrogen, oxygen, air, carbon monoxide, carbon dioxide, carbon tetrachloride, chloroform, hydrogen, ammonia, carbon tetrafluoride, trichlorofluoroethane and trifluoromethane. These gases maybe used alone or in combination. As for a pressure used in the treatment, it is preferred that the treatment is preferably carried out at a reduced pressure of 0.01 to 100 Torr, more preferably 0.05 to 10 Torr.

In the low-pressure plasma treatment, when the pressure is out of the above reduced-pressure range to a considerable extent, adhesion between the heat-resistant film and the resin becomes insufficient and a desired effect can not be obtained. Further, when the plasma treatment is carried out under a reduced pressure, the film surface is activated at a treatment electric power density lower than that of a case in which the treatment is carried out at a normal pressure, so that it is possible to form fine roughness. When the treatment electric power density is 10 to 80 W·sec/cm² which is lager than a usual treatment power density of a normal pressure treatment and, at the same time, the pressure is in the low-pressure treatment range of 0.01 to 100 Torr, the surface treatment effect becomes more effective. When the treatment electric power density is less than 10 W·sec/cm² under the above low-pressure condition, the effect is small with regard to the object of the present invention. When it is larger than 80 W·sec/cm², a problem such as a decrease in mechanical strength is apt to occur when a thin heat-resistant film having a thickness of 4to 5 μm is used. Concerning a treatment of more than 80 W·sec/cm², when devices having the same power source and the same electrode surface area are used, the period of time required for the treatment becomes longer. Therefore, for carrying out the treatment in a short time, a countermeasure such as an enlargement of power source of the treatment device is required.

In the present invention, the treatment electric power density is decided by a power source (W), a treatment area (cm²) and a treatment time (second). For example, a treatment electric power density of 10 W·sec/cm² corresponds to a treatment amount of a treatment of 10 W per 1 cm² of treatment area for 1 second. Further, the same treatment can be carried out by a treatment of 1 W per 1 cm² of treatment area for 10 seconds.

The present inventors have made studies on a surface-treatment of the heat-resistant film for a further improvement in the adhesive strength between the heat-resistant film and the resin and, as a result, found that, when a physical treatment as a preliminary treatment is carried out to form fine roughness on a film surface and then a surface-treatment is further carried out by low-pressure plasma treatment, the heat-resistant film and the resin are bonded more strongly even at a high temperature, so that heat resistance after moisture absorption is largely increased. That is, the present invention provides a heat-resistant filmbase-material-inserted B-staged resin composition sheet obtainable by preliminarily surface-treating a heat-resistant film by a physical treatment other than plasma treatment, then plasma-treating the heat-resistant film and adhering a B-staged resin composition to the heat-resistant film. Preferably, the above plasma treatment is a low-pressure plasma treatment and the above B-staged resin composition sheet is a metal-foil-adhered and heat-resistant film base-material-inserted B-staged resin composition sheet in which a metal foil adheres to one surface of the heat-resistant film base-material-inserted B-staged resin composition sheet. There are provided a heat-resistant film base-material-inserted B-staged resin composition sheet and a metal-foil-adhered and heat-resistant film base-material-inserted B-staged resin composition sheet in each of which the heat-resistant film is preferably a wholly aromatic polyamide film and the B-staged resin composition is preferably a cyanate ester resin composition. Further, there are provided a multilayer board using the above heat-resistant film base-material-inserted B-staged resin composition sheet in a buildup layer and/or a bonding layer, and a multilayer board using the metal-foil-adhered and heat-resistant film base-material-inserted B-staged resin composition sheet in a buildup layer.

The plasma-treated heat-resistant film base material is preferably vacuum-packed with an evaporated aluminum film so as not to be in contact with air or light or is preferably stored in a bag with an oxygen absorber therein. The resin composition is applied to at least one surface of the heat-resistant film and the applied resin composition is dried to B-stage it. Otherwise, a sheet obtained by forming a B-staged resin layer on one surface of a release film is disposed such that the resin composition surface of the release film faces the heat-resistant film, and the resultant set is laminated under heat and pressure to integrate it and to obtain a heat-resistant film base-material-inserted B-staged resin composition sheet. This sheet may have a metal foil adhered to one surface thereof. The manufacturing process is not specially limited to the above process.

In the present invention, the physical treatment other than the plasma treatment, used as a preliminary treatment for the heat-resistant film, is not specially limited so long as it is other than the plasma treatment and can form fine roughness on the surface of the heat-resistant film. For example, a known method such as sandblasting, wet blasting or buff polishing can be adopted.

In the present invention, the resin composition to be adhered to the plasma-treated surface of the heat-resistant film base material is not specially limited. For example, it can be selected from known resin compositions such as a resin composition (to be referred to as “resin composition for the (semi)additive process” hereinafter) on the surface of which a roughened surface having concave and convex portions can be formed by a treatment using a roughening solution and a resin composition for lamination used for a general glass-fabric-base material prepreg. The structure of the heat-resistant film base-material-inserted B-staged resin composition sheet of the present invention can be any one selected from a structure in which the resin composition for the (semi)additive process is adhered on one surface of the heat-resistant film base material and the resin composition for lamination is adhered to the other surface of the heat-resistant film base material, a structure in which the resin composition for the (semi)additive process is adhered to each surface of the heat-resistant film base material and a structure in which the resin composition for lamination is adhered to each surface of the heat-resistant film base material. The thickness of the resin layer is not specially limited, and it is selected depending upon use as required. When the thickness of the insulating layer after laminate-molding is adjusted to 30 μm or less, for example if the thickness of the heat-resistant film is 5 μm, the thickness of the resin layer on a front side is adjusted to 5 μm and the thickness of the resin layer on a lamination side is adjusted to approximately 25 μm. In this manner, although depending upon the thickness of a copper foil of an internal layer board and a copper foil survival rate, the insulating layer thickness is adjusted to 30 μm or less after the lamination.

The resin composition on which a circuit can be formed by the (semi)additive process, used in the resin composition layer of the heat-resistant film base-material-inserted B-staged resin composition sheet of the present invention, includes known ones such as a thermosetting type resin composition and a photo-curing and thermosetting combination type resin composition. The above resin composition layer contains a component soluble in a roughening solution, when subjected to curing treatment, and a resin component less-soluble in the roughening solution. The soluble component is homogeneously dispersed in the less-soluble resin component. Here, the meanings of the term “soluble” and the term “less soluble” used in the present invention are as follows. In cases of immersions in the same roughening solution for the same period of time after curing treatment, a component which has a relatively fast rate of dissolution is expressed as “soluble” and a component which has a relatively slow rate of dissolution is expressed as “less soluble”.

The soluble resin used in the resin composition for the (semi)additive method of the present invention can be selected from generally known soluble resins. This resin is a resin which is soluble in a solvent or a liquid resin. It is incorporated in the less-soluble resin. It is not specially limited. Specifically, it includes known ones such as polybutadiene rubber, acrylonitrile-butadiene rubber, epoxidized compounds, maleinized compounds, imidized compounds, carboxyl group-containing compounds, and (meth)acrylated compounds of these, and styrene-butadiene rubber. Particularly, resins having a butadiene structure in a molecule are preferably used in view of the solubility in the roughening solution or electric characteristics. Further, a resin containing a functional group is preferred as compared with a nonfunctional resin since it reacts with other unreacted resin functional groups in post-curing treatment to undergo crosslinking and improve characteristics. The resin composition for the (semi)additive process, used in the present invention, may contain an organic or inorganic powder which separates and escapes together with the component soluble in the roughening solution.

The organic powder used in the present invention can be selected from known ones. Specific examples thereof include powders of an epoxy resin, a polyimide resin, a polyphenylene ether resin, a polyolefine resin, a silicon resin, a phenol resin, acrylic rubber, polystyrene, MBS rubber, ABS, and the like, and multiple structure (core-shell) rubber powders of these. These powders may be used alone or in combination as required.

The inorganic powder used in the present invention is not specially limited. Examples thereof include aluminum compounds such as alumina and aluminum hydroxide; calcium compounds such as calcium carbonate; magnesium compounds such as magnesia; and silica compounds such as silica and zeolite. These may be used alone or in combination.

The less-soluble resin is selected from known thermosetting resins and the like. These resins may be used alone or in combination. The less-soluble resin is not specially limited. Specific examples thereof include an epoxy resin, a polyimide resin, a polyfunctional cyanate ester resin, a maleimide resin, a double-bond-addition polyphenylene ether resin, a polyphenylene ether resin, a polyolefine resin, epoxy acrylate, an unsaturated-group-containing polycarboxylic acid resin and a polyfunctional (meth)acrylate. Further, known brominated compounds and phosphorus-containing compounds of these can be used. Of these, a resin composition containing the polyfunctional cyanate ester resin as a main component is preferred in view of migration resistance, heat resistance, and heat resistance after moisture absorption. Particularly preferably, the above resin composition containing the polyfunctional cyanate ester resin is used in combination with an epoxy resin.

A polyfunctional cyanate ester compound which is preferably used in the above resin refers to a compound whose molecule contains at least two cyanato groups. Specific examples of the above polyfunctional cyanate ester compound include 1,3- or, 4-dicyanatobenzene, 1,3,5-tricyanatobenzene, 1,3-, 1,4-, 1,6-, 1,8-, 2,6- or 2,7-dicyanatonaphthalene, 1,3,6-tricyanatonaphthalene, 4,4-dicyanatobiphenyl, bis(4-dicyanatophenyl)methane, 2,2-bis(4-cyanatophenyl)propane, 2,2-bis(3,5-dibromo-4-cyanotophenyl)propane, bis(4-cyanatophenyl)ether, bis(4-cyanatophenyl)thioether, bis(4-cyanatophenyl) sulfone, tris(4-cyanatophenyl)phosphite, tris(4-cyanatophenyl)phosphate, and cyanates obtained by a reaction between novolak and cyan halide.

In addition to the above examples, there can be used polyfunctional cyanate ester compounds disclosed in Japanese Patent Publications Nos. 41-1928, 43-18468, 44-4791, 45-11712, 46-41112, 47-26853 and JP-A-51-63149. Further, prepolymers having a molecular weight of 400 to 6,000 and having a triazine ring formed by the trimerization of cyanato group of each of these polyfunctional cyanate ester compounds may be also used. The above prepolymer is obtained by polymerizing the above polyfunctional cyanate ester monomer in the presence of an acid such as a mineral acid or a Lewis acid; a base such as sodium alcoholate or a tertiary amine; or a salt such as sodium carbonate as a catalyst. The prepolymer partially contains an unreacted monomer and is in the form of a mixture of monomer with prepolymer, and this material is preferably used in the present invention. When used, generally, it is dissolved in an organic solvent in which it is soluble. There can be used bromine-added compounds of these and liquid resins.

The epoxy resin can be selected from an epoxy resin which is liquid at room temperature and an epoxy resin which is solid at room temperature. The epoxy resin which is liquid at room temperature can be generally selected from known epoxy resins. Specific examples thereof include a bisphenol A type epoxy resin, a bisphenol F type epoxy resin, a phenol novolak type epoxy resin, an alicyclic epoxy resin, diglycidyl compounds of polyether polyol, and epoxidized compounds of acid anhydride. These epoxy resins may be used alone or in combination. The amount of the epoxy resin per 100 parts by weight of the polyfunctional cyanate ester resin is 20 to 10,000 parts by weight, preferably 30 to 5,000 parts by weight. The term “liquid at room temperature” means “unbreakable at room temperature (25° C.)”. Besides the above liquid epoxy compounds, there may be used known solid epoxy resins which are breakable at room temperature, a cresol novolak type epoxy resin, a biphenyl type epoxy resin and a naphthalene type epoxy resin as a less soluble resin. These resins may be used alone or in combination.

The resin composition used in the present invention may contain various additives other than the above compounds as required so long as the inherent properties of the composition are not impaired. Examples of the additives include various resins, known bromine compounds and phosphorus compounds of these resins, various known additives such as inorganic or organic filler, a dye, a pigment, a thickener, a lubricant, an anti-foamer, a dispersing agent, a leveling agent, a photo-sensitizer, a flame retardant, a brightener, a polymerization inhibitor and a thixotropic agent. These additives may be used alone or in combination as required. A known curing agent or a known catalyst is incorporated into a compound having a reactive group as required.

When the resin composition used in the present invention has a low curing rate and thus it is poor in workability, economic performances and the like, a known curing catalyst is preferably added to the resin to be used. The amount of the catalyst per 100 parts by weight of the resin (solid content) is 0.005 to 10 parts by weight, preferably 0.01 to 5 parts by weight.

The total amount of the soluble resin, the organic powder and the inorganic powder which are homogeneously dispersed in the resin composition for the (semi)additive process in the present invention is not specially limited, while it is preferably 3 to 50% by weight, more preferably 5 to 35% by weight, based on the whole. At least two components of the above three components are used. The diameters of these components are preferably different rather than the same. When the diameters are different, the shape of roughness becomes more complicate, which increase an anchor effect. Therefore, a resin composition layer excellent in copper plating adhesive strength can be obtained.

The method of kneading the components of the present invention homogeneously may be selected from generally known methods. For example, the components are mixed and then the mixture is kneaded with a three-roll mill at room temperature or under heat. Otherwise, a generally known machine such as a ball mill, a mortar machine, a bead mill or a homomixer is used. Further, a viscosity is adjusted by adding a solvent so as to meet a processing method.

The resin composition for lamination used in the present invention is not specially limited and can be selected from known ones. Specifically, it includes the above-described less-soluble resins. In view of migration resistance, heat resistance and electric characteristics, the polyfunctional cyanate ester resin composition is preferably used. The less-soluble resins may be used alone or in combination as required. Furthermore, the above-described various additives may be added as required.

The structure of the heat-resistant film base-material-inserted B-staged resin composition sheet of the present invention may be any one selected from a structure in which the resin composition for the (semi)additive process is adhered on one surface of the heat-resistant film and the resin composition for lamination is adhered to the other surface of the heat-resistant film, a structure in which the resin composition for the (semi)additive process is adhered to each surface of the heat-resistant film and a structure in which the resin composition for lamination is adhered to each surface of the heat-resistant film. The method of producing the heat-resistant film base-material-inserted B-staged resin composition sheet is not specially limited and can be selected from known methods. For example, the resin composition is directly applied to the heat-resistant film with a roll and then dried to B-stage the resin composition. Otherwise, it is applied to a release film or a metal foil and then dried to B-stage the applied resin composition, then the resultant film or metal foil is disposed on one surface or each surface of the heat-resistant film and the resultant set is laminated under heat and under pressure to integrate it. In this case, a small amount of solvent may remain in the resin composition. The thickness of the resin composition is not specially limited, while it is generally 3 to 100 μm, preferably 4 to 50 μm, more preferably 5 to 30 μm, on the heat-resistant film. The above thickness is properly selected depending upon an intended insulating layer thickness. Owing to the use of the heat-resistant film, there can be produced a multilayer printed wiring board which is excellent in insulating properties in the Z direction and is excellent in reliability such as migration resistance.

The metal foil to be adhered to the B-staged resin composition, used in the present invention, is not specially limited. Specific examples thereof include copper foil and nickel foil. An electrolytic copper foil with a resin-adhesion surface (mat surface) having known roughness is preferably used in view of an increase in resin adhesive strength.

A copper foil used by the subtractive process, used in the present invention, is not specially limited, while an electrolytic copper foil having a thickness of 2 to 18 μm is preferably used. A metal foil which has roughness on a surface to be adhered to the B-staged resin composition for the (semi)additive process, used in the present invention, is not specially limited. Specifically, it is typically an aluminum foil or a copper foil. The roughness of the surface, to which the resin is to be adhered, is not specially limited, while the average roughness Rz is preferably 1 to 10 μm, more preferably 2 to 7 μm. This is because, when the roughness before roughening is large, the roughening time is short and penetration of water content is small so that swelling of a plated copper layer due to heating can be decreased. The thickness of the metal foil is not specially limited, while a small thickness is better in view of subsequent removal of the metal foil by etching or the like. A metal foil having a thickness of 9 to 20 μm is preferably used.

In the present invention, in the case of multilayer formation, an internal layer board obtained by forming a conductor circuit in a copper-clad laminate or a heat-resistant film base-material-reinforced copper-clad sheet is prepared and the conductor is treated by known surface treatment. Otherwise, an internal layer board which uses roughened foils on both surfaces is prepared. The above heat-resistant film base-material-inserted and release-film-adhered or metal-foil-adhered B-staged resin composition sheets are disposed on front and reverse surfaces, one on each surface, of the above internal layer board. Then, the resultant set was laminate-molded or laminated under heat and pressure preferably in vacuum according to a known method, to perform curing treatment. By the curing treatment, with regard to the resin composition for the (semi)additive process, a curing degree which allows roughening with a roughening solution is obtained. When the heat-resistant film base-material-inserted and metal-foil-adhered B-staged resin composition sheets are used, the metal foils are removed by etching or the like after the lamination-molding or the lamination.

The curing-treatment laminate-molding conditions for the multilayer formation in the present invention are not specially limited. Conditions under which roughening with an acid or an oxidizer can be properly carried out are selected depending on the resin composition used. Generally, the temperature is 60 to 300° C., preferably 60 to 250° C., the pressure is 5 to 50 kgf/cm² and the time is 0.5 to 3 hours. Further, the laminate-molding is preferably carried out in vacuum. A device can be selected from known devices such as a vacuum laminater press and a general multistage vacuum press.

After metal foil(s) or release film(s) of external layers of a metal-foil-clad board or a release-film-clad board obtained by using the resin composition for the (semi)additive process are removed, the resin layer(s) are roughened with an acid or an oxidizer by a known method. The acid to be used includes sulfuric acid, hydrochloric acid, nitric acid, phosphoric acid and formic acid. The oxidizer includes sodium permanganate, potassium permanganate, chromic acid and chrome sulfuric acid. The acid and the oxidizer are not limited to these. Before the above treatment, a known swelling liquid is used as required. After the treatment, neutralization is carried out with a neutralization liquid. The average roughness of a roughened surface formed by above roughening treatment is 0.1 to 10 μm, preferably 0.2 to 5 μm, as an average roughness Rz, besides the roughness of the metal foil. The total roughness of the roughness of the metal foil and the roughness formed by the roughening treatment is generally 2 to 15 μm, preferably 3 to 12 μm, as an average roughness RZ.

Thereafter, electroless plating, thickening electroless plating, deposition, sputtering, etc., are carried out by a known semi-additive process or full-additive process, and electroplating is carried out as required, to thicken a conductor. Although depending upon the constitution of the resin composition, when the B-staged resin composition layer has a curing degree which allows roughening with a chemical and is directly used to prepare a printed wiring board, the obtained printed wiring board is generally poor in heat resistance and reliability and can not be used as a high-density printed wiring board. Therefore, post-curing is generally carried out before forming a circuit. The post-curing is carried out at a temperature of 100 to 250° C. for 30 minutes to 5 hours, although these conditions differ depending upon the constitution of the resin composition. Then, a circuit is formed by a known method, thereby producing a printed wiring board. Buildup is carried out by repeating the same steps sequentially, to form a multilayer structure.

The heat-resistant film base-material-inserted B-staged resin composition sheet can be used also as a prepreg for a general copper-clad laminate or a multilayer board. It is also possible to carry out lamination using copper foils and produce a printed wiring board by the subtractive process. The heat-resistant film base-material-inserted B-staged resin composition sheet is used by a known method.

Then, the manufacturing process of a multilayer board, provided by the present invention, is explained. The manufacturing process of a multilayer board, provided by the present invention, is a process of manufacturing a multilayer board by laminating a conductor circuit and an interlayer resin insulating layer on a substrate sequentially and forming the multilayer board according to a buildup method, or a process of manufacturing a multilayer board by disposing an internal layer board and a sheet for lamination concurrently to integrate them and carrying out lamination at a time, in each of which the heat-resistant film base-material-inserted B-staged resin composition sheet is used as an adhesive sheet, molding is carried out with a preheated hot plate in vacuum in a short time, and post-curing is carried out with a heating furnace such as an oven. According to the manufacturing process of the present invention, the post-curing can be carried out in large quantities at a time so that there is an advantage that it is excellent in mass productivity. The manufacturing process of the present invention is characterized in that the heat-resistant film base-material-inserted B-staged resin composition sheet is used as an adhesive sheet in place of a conventional prepreg using a woven fabric or a non-woven-fabric and that the lamination can be carried out without using a multistage press of a batch method.

In the multilayer board manufacturing process of the present invention, internal layer board(s) obtained by forming a conductor circuit on a copper-clad laminate or a heat-resistant film base material-reinforced copper-clad sheet or the like are prepared and the conductor circuit is subjected to a known surface treatment. Otherwise, internal layer board(s) which have roughened foils on both surfaces are prepared. Then, the above heat-resistant film base-material-inserted and release-film-adhered or metal-foil-adhered B-staged resin composition sheets are disposed on front and reverse surfaces of the above-prepared internal layer board or between the internal layer boards. While the resultant set is preferably continuously fed, the above set is preferably preheated with a heating roll or in a room for lamination and then semi-cured under pressure by pinching the above set from the upper and lower sides with smooth-surface hot plates heated in advance. Preferably, the laminate-molding is carried out in vacuum to carry out the semi-curing treatment and the resultant laminate is taken out and then post-cured in a heating furnace to cure it completely.

Preheating conditions in the present invention are not specially limited, while the conditions are properly selected depending upon the resin composition. Generally, the preheating is carried out at 60 to 150° C. for 30 seconds to 5 minutes. When lamination is carried out with a roll, it is carried out at a linear load of 1 to 10 kgf/cm. Further, laminate-molding conditions of the subsequent semi-curing treatment are not specially limited. The semi-curing is carried out until the resin is cured to some extent and bonded to the internal layer board such that the resin is not peeled off in the subsequent post-curing. Generally, the semi-curing is carried out at a temperature of 60 to 250° C. at a pressure of 2 to 50 kgf/cm² for 1 to 30 minutes. Further, it is preferred to carry out the laminate-molding in vacuum in view of preventing the occurrence of voids. The resin which forms an external layer of the heat-resistant film base-material-inserted B-staged resin composition sheet may be a resin for the additive process.

Effect of the Invention

The adhesive sheet for a printed wiring board obtained by plasma-treating a surface of the heat-resistant film base material and then adhering the B-staged resin composition layer to it, provided by the present invention, can give a high-density printed wiring board which is particularly excellent in heat resistance after moisture absorption, has a small insulating layer thickness after molding of 30 μm or less and is excellent in reliability such as electric insulation in the Z direction.

The adhesive sheet for a printed wiring board obtained by plasma-treating a surface of the heat resistant film base material under a reduced pressure and then adhering the B-staged resin layer to it, provided by the present invention, can decrease the insulating layer thickness after molding to 30 μm or less, decrease the variance of thickness after molding and can give a high-density printed wiring board which is particularly excellent in heat resistance after moisture absorption and also excellent in reliability such as electric insulation in the Z direction and has excellent elastic modulus.

The heat-resistant film base-material-inserted B-staged resin composition sheet of the present invention is obtained by adhering the thermosetting resin composition having a glass transition temperature, after curing, of at least 180° C. on at least one surface of the heat-resistant film base material surface-treated by plasma treatment. The B-staged resin composition sheet of the present invention can decrease the insulating layer thickness, after molding, down to 30 μm or less, and decrease the thickness variance after molding. The B-staged resin composition sheet of the present invention can give a high-density printed wiring board which is particularly excellent in heat resistance after moisture absorption and also excellent in reliability such as electric insulation in the Z direction and has excellent elastic modulus.

In the manufacturing process of a multilayer board, provided by the present invention, the heat-resistant film base-material-inserted B-staged resin composition sheet(s) obtained by adhering the resin composition layer to the heat-resistant film base material is/are disposed on conductor circuit substrate(s) or on and between the conductor circuit substrates and a metal foil is disposed as an outermost layer, the resultant set is bonded with a smooth and flat heating plate under a pressure to semi-cure the resin composition, and then it is taken out, placed in a heating furnace and then completely cured under heat. The above process of the present invention is excellent in mass productivity, can decrease the insulating layer thickness, after molding, to 30 μm or less and can give a high-density printed wiring board which is excellent in thickness variance and excellent in reliability such as migration resistance in the Z direction.

A printed wiring board high in insulation reliability in the Z direction and excellent in migration resistance and heat resistance after moisture absorption can be obtained by using the heat-resistant filmbase-material-inserted B-staged resin composition sheet of the present invention in a multilayer board. As compared with a printed wiring board using a conventional B-staged resin composition sheet having no base material, the present printed wiring board is high in mechanical strength, small in warp and distortion and excellent in molding thickness at the time of lamination, so that it is suitable for a high-density printed wiring board of the subtractive process or the (semi)additive process.

### EXAMPLES

The present invention will be concretely explained with reference to Examples and Comparative Examples hereinafter, in which “part” stands for “part by weight” unless otherwise specified.

### Example 1

400 Parts of 2,2-bis(4-cyanatophenyl)propane monomer was melted at 150° C. and allowed to react for 4hours with stirring, to prepare a prepolymer having an average molecular weight of 1,900. The prepolymer was dissolved in methyl ethyl ketone, to prepare a solution. To the solution were added, as epoxy resins liquid at room temperature, 100 parts of a bisphenol A type epoxy resin (trade name: Epikote 828, supplied by Japan epoxy resin), 50 parts of a bisphenol F type epoxy resin (trade name: EXA830LVP, supplied by Dainippon Ink And Chemicals, Incorporated), 50 parts of a novolak type epoxy resin (trade name: DEN438, supplied by Dow Chemical) and 400 parts of a bisphenol A type epoxy resin (trade name: Epikote 1001 supplied by Japan epoxy resin). 0.3 part of zinc octylate dissolved in methyl ethyl ketone was added as a heat-curing catalyst. 100 parts of a liquid epoxidized polybutadiene resin (trade name: E-1000-8.0, supplied by NIPPON PETROCHEMICALS CO., LTD) and 30 parts of an epoxy-group-modified acryl multilayer structure powder (trade name: STAPHYLOID IM-203, average particle diameter 0.2 μm) were added to the resultant mixture, and the mixture was stirred and mixed to prepare a homogeneous varnish.

The above varnish was continuously applied to a mat surface (roughness 3.0 to 5.9 μm, average roughness Rz: 4.6 μm) of a copper foil having a thickness of 18 μm and dried to form a B-staged resin composition layer (gelation time at 170° C.: 48 seconds) which had a height, from the tip of the maximum convex portion of the copper foil, of 5.5 μm. When the copper foil with the B-staged resin layer thereon came out from a drying zone, a protective polypropylene film having a thickness of 20 μm was disposed on the resin composition surface. These materials were laminated at 100° C. at a linear load of 4 kgf/cm to prepare a copper-foil-adhered B-staged resin composition sheet.

A varnish was prepared in the same manner as in the above varnish preparation except that the liquid epoxidized polybutadiene resin and the epoxy-group-modified acryl multilayer structure powder were not used. The varnish was continuously applied to one surface of a 25 μm thick release PET film, and the applied varnish was dried to obtain a B-staged resin layer having a gelation time of 67 seconds and a thickness of 20 μm. At the time when the resultant film came out from a drying zone, a 20 μm thick polypropylene protective film was placed on the resin layer surface. These materials were laminated at 100° C. under a linear load of 4 kgf/cm, to prepare a release film-adhered B-staged resin composition sheet. This sheet was disposed on one surface of a 4.5 μm thick wholly aromatic polyamide film, whose both surfaces had been plasma-treated at 500 W for 7 minutes and had a contact angle of 1 degree with water, while separating the protective film, the above-obtained copper-foil-adhered B-staged resin composition sheet was disposed on the other surface of the wholly aromatic polyamide film while separating the protective film, and these materials were continuously laminated at 90° C. at a linear load of 7 kgf/cm to integrate them, whereby heat-resistant film base-material-inserted and copper-foil-adhered B-staged resin composition sheets were produced. The insulating layer thickness thereof was 30 μm from the tip of a copper foil convex portion.

Separately, circuits were formed on a BT resin copper-clad laminate having an insulating layer thickness of 0.2 mm and having 12 μm thick copper foils on both surfaces (trade name: CCL-HL830, supplied by Mitsubishi Gas Chemical Company, INC.) and then the copper foils were treated to form black copper oxide, where by an internal layer board was prepared. The above heat-resistant film base-material-inserted and copper-foil-adhered B-staged resin composition sheets were disposed on both surfaces of the internal layer board with separating the release PET films such that the resin layer surfaces faced to the internal layer board. The resultant set was placed in a press machine and temperature-increased from room temperature to 170° C. over 25 minutes, a pressure of 15 kgf/cm² was applied from the beginning, and the above set was maintained at 170° C. for 30 minutes at a vacuum degree of 3 mmHg or less. Then, it was cooled and taken out, to obtain a multilayer board having four layers. The copper foils on the external surfaces were removed by etching. Then, the resultant surfaces were 1-shot irradiated with a carbon dioxide gas laser at an output of 10 mJ to make blind via holes having a diameter of 95 μm each. Swelling and desmearing (dissolution) were carried out with a potassium permanganate type desmear solution (Nippon MacDermid Co., Inc.) and neutralization was carried out, to make a total roughness, from the external layer, of 3.8 to 6.0 μm (average roughness Rz: 5.1 μm). At the same time, the resin layer remaining in the bottom of each blind via hole was dissolved and removed. Then, the roughened surfaces were plated to form an electroless copper plating layer having a thickness of 0.5 μm on each roughened surface and plated to form an electrolytic copper plating layer having a thickness of 20 μm on each surface. The multilayer board was placed in a heating furnace, gradually temperature-increased from 100° C. to 150° C. over 30 minutes, further gradually temperature-increased to 190° C. and cured under heat at 190° C. for 60 minutes. The thickness of the insulating layer was measured in a cross section and it was almost 25 μm. Copper conductor circuits were formed on the board according to the semi-additive process, and the copper conductor circuit surfaces were subjected to black copper oxide treatment. The same steps were repeated to produce a multilayer printed wiring board having six layers. The printed wiring board was measured for properties and Table 1 shows results thereof.

### Example 2

400 Parts of 2,2-bis(4-cyanatophenyl)ether monomer was melted at 150° C. and allowed to react for 4hours with stirring, to prepare a prepolymer having an average molecular weight of 1,900. The prepolymer was dissolved in methyl ethyl ketone. To the resultant solution were added 100 parts of a bisphenol A type epoxy resin (trade name: Epikote 828), 150 parts of a bisphenol F type epoxy resin (trade name: EXA830LVP), 150 parts of a novolak type epoxy resin (trade name: DEN438) and 200 parts of a cresol novolak type epoxy resin (trade name: ESCN220F, supplied by Sumitomo Chemical Co., Ltd.) as epoxy resins liquid at room temperature. As a heat-curing catalyst, 0.3 part of iron acetylacetonate dissolved in methyl ethyl ketone was added thereto. 400 parts of talc (average particle diameter 1.8 μm, maximum particle diameter 4.2 μm) was added to the resultant mixture, and these materials were homogeneously stirred and mixed, to prepare a homogeneous varnish.

The above varnish was continuously applied to one surface of a 25 μm thick release PET film having a smooth surface, and the applied varnish was dried to obtain a B-staged resin layer having a gelation time of 60 seconds and a thickness of 18 μm, whereby a release-film-adhered B-staged resin composition sheet was obtained. Further, a release-film-adhered B-staged resin composition sheet having a B-staged resin layer having a gelation time of 64 seconds and a thickness of 5 μm was obtained. A 20 μm thick protective polyethylene film was attached to the resin layer surface of each of the above two kinds of sheets at the time when each of the sheets came out from a drying zone, and each of the resultant sets was intergraded respectively. Both surfaces of a 12 μm thick polyimide film were plasma-treated at 500 W for 10 seconds such that both the surfaces had a water contact angle of 21 degree. Two kinds of the above release film-adhered B-staged resin composition sheets were disposed on both the plasma-treated surfaces of the polyimide film with separating the protective films, and these materials were laminated at 100° C. under a linear load of 4 kgf/cm, whereby heat-resistant filmbase-material-inserted B-staged resin composition sheets having a total thickness of 35 μm each were prepared.

Separately, circuits of a copper survival rate of 30% were formed on a BT resin copper-clad laminate having an insulating layer thickness of 0.2 mm and having 18 μm thick copper foils on both surfaces (trade name: CCL-HL830, supplied by Mitsubishi Gas Chemical Company, INC.) and then the copper foils were treated to form black copper oxide, whereby an internal layer board was obtained. The above heat-resistant film base-material-inserted B-staged resin composition sheet was disposed on each surface of the internal layer board while separating the release PET film on one surface of the B-staged resin composition sheet such that the resin layer faced to the internal layer board side. These B-staged resin composition sheets were laminate-bonded to the internal layer board at 100° C. at a linear load of 5 kgf/cm, and then the release PET films on the external layers were peeled off. Copper foils (trade name: Super Thin foil, supplied by Mitsui Mining and Smelting Co., Ltd.) obtained by bonding a 3 μm thick general electrolytic copper foil to a 35 μm thick copper carrier sheet were disposed on both the surfaces, one copper foil on each surface. The resultant set was laminate-molded under a vacuum of 30 mmHg or less for 2 hours at 110° C.∘30 minutes+200° C.∘90 minutes and 5 kgf/cm²∘20 minutes+20 kgf/cm²∘100 minutes. The resultant board had an insulation layer thickness of almost 23 μm. The copper carrier sheets on the surfaces were removed. Each surface of the board was 1 shot irradiated directly with a carbon dioxide gas laser at an output of 13 mJ to make blind via holes having a diameter of 100 μm. After desmear treatment, electroless copper plating was adhered to form a layer having a thickness of 0.5 μm on each surface and electrolytic copper plating was adhered to form a layer having a thickness of 10 μm on each surface. Then, circuits were formed by a general method. Black copper oxide treatment was carried out and then the above-prepared heat-resistant film base-material-inserted B-staged resin composition sheets were similarly disposed with separating the release films, and the resultant set was similarly processed to produce a six-layered printed wiring board. Table 2 shows results of evaluation of this printed wiring board.

### Example 3

500 parts of a bisphenol A type epoxy resin (trade name: Epikote 1001), 450 parts of a phenol novolak type epoxy resin (trade name: DEN438), 30 parts of an imidazole type curing agent (trade name: 2E4MZ, supplied by Shikoku Corporation) and 400 parts of talc (average particle diameter 1.8 μm, maximum particle diameter 4.2 μm) were uniformly dispersed with a three-roll mill, to prepare a varnish. The above varnish was continuously applied to a 25 μm thick release PET film having a smooth surface and the applied varnish was dried, whereby release-film-adhered B-staged resin composition sheets having a resin composition thickness of 20 μm and a gelation time of 68 seconds were obtained. Both surfaces of a 4.5 μm thick wholly aromatic polyamide film were plasma-treated at 900 W for 10 minutes such that both the surfaces had a water contact angle of 0 degree. The above release film-adhered B-staged resin composition sheets were disposed on both the surfaces of the polyamide film, one sheet on each surface, and these materials were continuously laminated with a heating roll at 100° C. under a linear load of 5 kgf/cm, whereby heat-resistant film base-material-inserted and release-film-adhered B-staged resin composition sheets were prepared. The heat-resistant film base-material-inserted and release-film-adhered B-staged resin composition sheet had an insulating layer thickness of almost 45 μm.

Separately, circuits of a copper survival rate of 30% were formed on an epoxy type copper-clad laminate having a thickness of 0.2 mm and having 18 μm thick copper foils on both surfaces (trade name: CCL-EL170, supplied by Mitsubishi Gas Chemical Company, INC.) and then conductors were treated to form black copper oxide, whereby internal layer boards were prepared. The above heat-resistant filmbase-material-inserted and release-film-adhered B-staged resin composition sheets were disposed on both surfaces of the internal layer board, one sheet on each surface, such that the resin layers faced to the internal layer board side. These materials were laminated at 100° C. at a linear load of 5 kgf/cm, to produce a double-side sheet-adhered substrate. Further, the above heat-resistant film-base-material-inserted and release film-adhered B-staged resin composition sheet was similarly bonded to one surface of the internal layer board, to prepare a single-side sheet-adhered substrate. The release PET films of these substrates were separated. The double-side sheet-adhered substrate was disposed on a surface of the single-side sheet-adhered substrate which surface was opposite to the sheet-adhered surface. General electrolytic copper foils having a thickness of 12 μm were disposed on both surfaces of the resultant set. These materials were laminate-molded under a vacuum of 30 mmHg or less for 2 hours at 110° C.●30 minutes+180° C.●90 minutes and 5 kgf/cm²●15 minutes+20 kgf/cm²●105 minutes, to prepare a six-layered board. Then, a printed wiring board was prepared by a conventional method. The thickness of the insulating layer between the internal layers was about 20 μm. Table 2 shows results of evaluation of this printed wiring board.

### Comparative Example 1

In Example 1, the thickness of the B-staged resin layer adhered to the roughness of the copper foil was changed to 30 μm from the tip of a convex portion, to prepare a metal-foil-adhered B-staged resin composition sheet. A laminate-molding curing treatment was similarly carried out by using only the above metal-foil-adhered B-staged resin composition sheet without using the heat-resistant film base material used in Example 1. A roughening treatment was similarly carried out, whereby almost the same total roughness from the external layer as that in Example 1 was obtained. A multilayer printed wiring board having six layers was similarly produced. Table 1 shows evaluation results thereof.

### Comparative Example 2

In Example 1, a heat-resistant base-material-inserted B-staged resin composition sheet was similarly produced by using a wholly aromatic polyamide film whose both surfaces had not been treated. A six-layered printed wiring board was similarly produced. In this case, the water contact angle was 60 degree. Table 1 shows evaluation results thereof.

### Comparative Examples 3 and 4

In Example 2 and Example 3, glass woven fabrics having a thickness of 20 μm were impregnated with the varnish obtained in Example 2 and the varnish obtained in Example 3 respectively and dried, to obtain a prepreg having a gelation time of 76 seconds and a thickness of 35 μm and a prepreg having a gelation time of 100 seconds and a thickness of 45 μm. These prepregs was similarly used for laminate-molding respectively, and printed wiring boards having six layers were similarly produced. Table 2 shows evaluation results of the obtained printed wiring boards.

TABLE 1

| | |
|---|---|
| Example | Comparative Examples |

| Item | 1 | 1 | 2 |
|---|---|---|---|
| Copper adhesive strength | 1.07 | 1.08 | 1.07 |
| (kgf/cm) | | | |
| Heat resistance in | No failure | No failure | Many |
| soldering after moisture | | | swellings |
| absorption | | | occurred |
| Glass transition | 195 | 192 | 195 |
| temperature DMA (° C.) | | | |
| Elastic modulus 25° C. | 1,577 | 995 | 1,570 |
| (kgf/mm²) | | | |
| Warp ∘ distortion (mm) | 1.2 | 5.3 | 1.3 |
| Thickness variance (μm) | 3.0 | 6.1 | 3.0 |
| Migration resistance in | | | |
| Z direction (Ω) | | | |
| Ordinary state | 6 × 10¹³ | 5 × 10¹³ | — |
| 200 hrs. | 6 × 10¹¹ | 6 × 10¹⁰ | |
| 1,000 hrs. | 3 × 10¹⁰ | <10⁸ | |

TABLE 2

| | Examples | | Comparative Examples | |
|---|---|---|---|---|
| Item | 2 | 3 | 3 | 4 |
| Glass transition | 216 | 165 | 216 | 158 |
| temperature DMA (° C.) | | | | |
| Heat resistance in | No failure | No failure | Slightly | No failure |
| soldering after moisture | | | swelling | |
| absorption | | | | |
| Thickness variance (μm) | 3.3 | 5.7 | 9.1 | 18.0 |
| Migration resistance in | | | | |
| Z direction (Ω) | | | | |
| Ordinary state | 5 × 10¹³ | 5 × 10¹³ | 5 × 10¹³ | 6 × 10¹³ |
| 100 hrs. | 4 × 10¹¹ | 5 × 10¹⁰ | 3 × 10¹⁰ | 7 × 10⁸ |
| 500 hrs. | 2 × 10¹¹ | 2 × 10⁹ | 1 × 10¹⁰ | <10⁸ |
| Migration resistance in | | | | |
| X direction (Ω) | | | | |
| Ordinary state | 6 × 10¹³ | 4 × 10¹³ | — | — |
| 100 hrs. | 5 × 10¹¹ | 2 × 10¹⁰ | — | — |
| 500 hrs. | 6 × 10¹⁰ | <10¹⁰ | — | — |

<Measurement Methods>

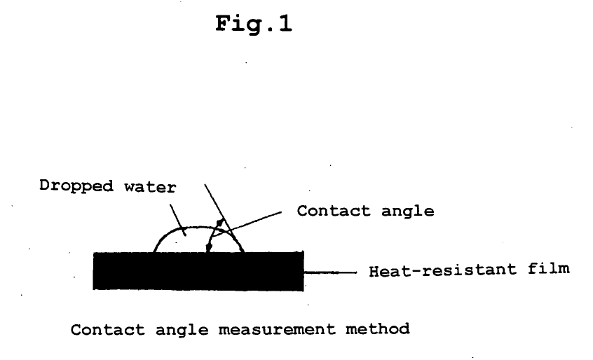

1) Measurement of water contact angle on heat-resistant film: Water was dropped on a heat-resistant film with a dropping pipette at 25° C. under 65% RH so as to have a diameter of 1.5 mm, and a contact angle shown in FIG. 1 was measured.

2) Copper adhesive strength: Measured according to JIS C6481.

3) Heat resistance in soldering after moisture absorption: After pressure cooker test treatment (PCT: 121° C. ∘203 kPa ∘ 4 hours), a printed wiring board having six layers was immersed in solder at 260° C. for 30 seconds and then checked for failures.

4) Grass transition temperature: Each varnish was applied to a copper foil surface and dried several times to have a thickness of about 0.8 mm. Then, a copper foil was placed on the resin composition surface and the resin composition layer was cured under each lamination curing condition. The copper foils on the external layers were etched. Then, a grass transition temperature was measured by DMA method. In Comparative Examples 3 and 4, a plurality of prepregs were laminate-molded to have a thickness of about 0.8 mm and the obtained laminate was used.

5) Elastic modulus: Table 1 shows elastic modulus at 25° C. in the chart of DMA measured in 4).

6) Warp ∘ distortion: A six-layered printed wiring board having a size of 250×250 mm was placed on a surface plate and a maximum value of warp or distortion was measured.

7) Thickness variance: One layer of the same six-layered printed wiring board having a size of 250×250 mm as that in 6) was measured for thickness variance with a thickness measurement apparatus. It was represented by (maximum value—minimum value).

8) Migration resistance in Z direction: Copper foil portions having a size of 10×10 mm were left in the second layer and the third layer of the six-layered board of each of Examples and Comparative Examples at the same positions. 100 such copper foil portions were connected. The board was measured for insulating resistance in the insulating layer in the Z direction at 85° C.∘85% RH under application of 70 VDC.

9) Migration resistance in X direction: Comb-shaped patterns of line/space=50/50 μm were made in the second layer and the third layer of the six-layered board of each of Examples and Comparative Examples. 100 comb-shaped patterns were connected. The board was measured for insulating resistance in the X direction at 85° C.∘85% RH under application of 50 VDC.

### Example 4

400Parts of2,2-bis(4-cyanatophenyl)propane monomer was melted at 150° C. and allowed to react for 4 hours with stirring, to prepare a prepolymer having an average molecular weight of 1,900. The prepolymer was dissolved in methyl ethyl ketone, to prepare a solution. To the solution were added, as epoxy resins liquid at room temperature, 100 parts of a bisphenol A type epoxy resin (trade name: Epikote 828, supplied by Japan epoxy resin), 50 parts of a bisphenol F type epoxy resin (trade name: EXA830LVP, supplied by Dainippon Ink And Chemicals, Incorporated), 50 parts of a novolak type epoxy resin (trade name: DEN438, supplied by Dow Chemical) and 400 parts of a bisphenol A type epoxy resin (trade name: Epikote 1001 supplied by Japan epoxy resin). 0.3 part of zinc octylate dissolved in methyl ethyl ketone was added as a heat-curing catalyst. 100 parts of a liquid epoxidized polybutadiene resin (trade name: E-1000-8.0, supplied by NIPPON PETROCHEMICALS CO., LTD) and 30 parts of an epoxy-group-modified acryl multilayer structure powder (trade name: STAPHYLOID IM-203, average particle diameter 0.2 μm) were added to the resultant mixture, and the mixture was stirred and mixed to prepare a homogeneous varnish.

The above varnish was continuously applied to a mat surface (roughness 3.0 to 5.9 μm, average roughness Rz: 4.6 μm) of a copper foil having a thickness of 18 μm and dried to form a B-staged resin composition layer (gelation time at 170° C.: 48 seconds) which had a height, from the tip of the maximum convex portion of the copper foil, of 5.5 μm. When the copper foil with the B-staged resin layer thereon came out from a drying zone, a protective polypropylene film having a thickness of 20 μm was disposed on the resin composition surface. These materials were laminated at 100° C. at a linear load of 4 kgf/cm to prepare a copper-foil-adhered B-staged resin composition sheet. The resin composition used in this sheet was measured for a glass transition temperature after curing (Tg) by DMA, and it was 185° C.

A varnish was prepared in the same manner as in the above varnish preparation except that the liquid epoxidized polybutadiene resin and the epoxy-group-modified acryl multilayer structure powder were not used. The varnish was continuously applied to one surface of a 25 μm thick release PET film, and the applied varnish was dried to obtain a B-staged resin layer having a gelation time of 67 seconds and a thickness of 20 μm. At the time when the resultant film came out from a drying zone, a 20 μm thick polypropylene protective film was placed on the resin layer surface. These materials were laminated at 100° C. under a linear load of 4 kgf/cm, to prepare a release film-adhered B-staged resin composition sheet. The glass transition temperature, after curing, of the resin composition used in this sheet was 201° C. This sheet was disposed on one surface of a 4.5 μm thick wholly aromatic polyamide film, whose both surfaces had been plasma-treated under a reduced pressure under conditions shown in Table 3, while separating the protective film, the above-obtained copper-foil-adhered B-staged resin composition sheet was disposed on the other surface of the wholly aromatic polyamide film while separating the protective film, and these materials were continuously laminated at 90° C. at a linear load of 7 kgf/cm to integrate them, whereby heat-resistant film base-material-inserted and copper-foil-adhered B-staged resin composition sheets were produced. The insulating layer thickness thereof was 30 μm from the tip of a copper foil convex portion.

Separately, circuits were formed on a BT resin copper-clad laminate having an insulating layer thickness of 0.2 mm and having 12 μm thick copper foils on both surfaces (trade name: CCL-HL830, supplied by Mitsubishi Gas Chemical Company, INC.) and then the copper foils were treated to form black copper oxide, whereby an internal layer board was obtained. The above heat-resistant film base-material-inserted and copper-foil-adhered B-staged resin composition sheet were disposed on both surfaces of the internal layer board with separating the release PET films such that the resin layer surfaces faced to the internal layer board. The resultant set was placed in a press machine and temperature-increased from room temperature to 170° C. over 25 minutes, a pressure of 15 kgf/cm² was applied from the beginning, and the above set was maintained at 170° C. for 30 minutes at a vacuum degree of 3 mmHg or less. Then, it was cooled and taken out, to obtain a multilayer board having four layers. The copper foils on the external surfaces were removed by etching. Then, the resultant surfaces were 1-shot irradiated with a carbon dioxide gas laser at an output of 10 mJ to make blind via holes having a diameter of 95 μm each. Swelling and desmearing (dissolution) were carried out with a potassium permanganate type desmear solution (Nippon MacDermid Co., Inc.) and neutralization was carried out, to make a total roughness, from the external layer, of 3.8 to 6.0 μm (average roughness Rz: 5.1 μm). At the same time, the resin layer remaining in the bottom of each blind via hole was dissolved and removed. Then, the roughened surfaces were plated to form an electroless copper plating layer having a thickness of 0.5 μm on each surface and plated to form an electrolytic copper plating layer having a thickness of 20 μm on each surface. The multilayer board was placed in a heating furnace, gradually temperature-increased from 100° C. to 150° C. over 30 minutes, further gradually temperature-increased to 190° C. and cured under heat at 190° C. for 60 minutes. The thickness of the insulating layer was measured in a cross section and it was almost 25 μm. Copper conductor circuits were formed on the board according to the semi-additive process, and the copper conductor circuit surfaces were subjected to black copper oxide treatment. The same steps were repeated to produce a multilayer printed wiring board having six layers. The printed wiring board was measured for properties and Table 3 shows results thereof.

TABLE 3

| | Example 4-1 | Example 4-2 | Example 4-3 |
|---|---|---|---|
| Low-pressure plasma | Oxygen gas | He gas | Nitrogen gas |
| treatment conditions | 60 W · sec./ | 30 W · sec./ | 70 W · sec./cm² |
| | cm² | cm² | |
| | 0.10 Torr | 0.10 Torr | 0.10 Torr |
| Copper adhesive strength | 1.07 | 1.05 | 1.07 |
| (kgf/cm) | | | |
| Heat resistance in | | | |
| soldering after moisture | | | |
| absorption | | | |
| ∘PCT-0 hrs. | No swelling | No swelling | No swelling |
| ∘PCT-1 hrs. | No swelling | No swelling | No swelling |
| ∘PCT-3 hrs. | No swelling | No swelling | No swelling |
| Glass transition | 195 | 195 | 195 |
| temperature DMA (° C.) | | | |
| Elastic modulus 25° C. | 1,577 | 1,573 | 1,575 |
| (kgf/mm²) | | | |
| Warp ∘ distortion (mm) | 1.2 | 1.2 | 1.2 |
| Thickness variance (μm) | 3.0 | 3.1 | 3.0 |
| Migration resistance in | | | |
| Z direction (Ω) | | | |
| Ordinary state | 6 × 10¹³ | 6 × 10¹³ | 6 × 10¹³ |
| 200 hrs. | 6 × 10¹¹ | 6 × 10¹¹ | 6 × 10¹¹ |
| 1,000 hrs. | 3 × 10¹⁰ | 3 × 10¹⁰ | 3 × 10¹⁰ |

### Example 5

400 Parts of 2,2-bis(4-cyanatophenyl)ether monomer was melted at 150° C. and allowed to react for 4 hours with stirring, to prepare a prepolymer having an average molecular weight of 1,900. The prepolymer was dissolved in methyl ethyl ketone. To the resultant solution were added 100 parts of a bisphenol A type epoxy resin (trade name: Epikote 828), 150 parts of a bisphenol F type epoxy resin (trade name: EXA830LVP), 150 parts of a novolak type epoxy resin (trade name: DEN438) and 200 parts of a cresol novolak type epoxy resin (trade name: ESCN220F, supplied by Sumitomo Chemical Co., Ltd.) as epoxy resins liquid at room temperature. As a heat-curing catalyst, 0.3 part of iron acetylacetonate dissolved in methyl ethyl ketone was added, and these materials were homogeneously stirred and mixed, to prepare a homogeneous varnish.

The above varnish was continuously applied to one surface of a 25 μm thick release PET film having a smooth surface, and the applied varnish was dried to obtain a B-staged resin layer having a gelation time of 60 seconds and a thickness of 18 μm, whereby a release-film-adhered B-staged resin composition sheet was obtained. Further, a release-film-adhered B-staged resin composition sheet having a B-staged resin layer having a gelation time of 64 seconds and a thickness of 5 μm was obtained. A 20 μm thick protective polyethylene film was attached to the resin layer surface of each of the above two kinds of sheets at the time when each of the sheets came out from a drying zone, and each of the resultant sets was intergraded respectively. The glass transition temperature, after curing, of these sheets was 210° C. Both surfaces of a 12 μm thick polyimide film were plasma-treated under a reduced pressure under conditions shown in Table 4. Two kinds of the above release film-adhered B-staged resin composition sheets were disposed on both the plasma-treated surfaces of the polyimide film with separating the protective films, and these materials were laminated at 100° C. under a linear load of 4 kgf/cm, whereby heat-resistant film base-material-inserted B-staged resin composition sheets having a total thickness of 35 μm were prepared.

Separately, circuits of a copper survival rate of 30% were formed on a BT resin copper-clad laminate having an insulating layer thickness of 0.2 mm and having 18 μm thick copper foils on both surfaces (trade name: CCL-HL830, supplied by Mitsubishi Gas Chemical Company, INC.) and then the copper foils were treated to form black copper oxide, whereby an internal layer board was prepared. The above heat-resistant film base-material-inserted B-staged resin composition sheet was disposed on each surface of the internal layer board while separating the release PET film on one surface of the B-staged resin composition sheet such that the resin layer faced to the internal layer board side. These B-staged resin composition sheets were laminate-bonded to the internal layer board at 100° C. at a linear load of 5 kgf/cm, and then the release PET films on the external layers were peeled off. Copper foils (trade name: Super Thin foil, supplied by Mitsui Mining and Smelting Co., Ltd.) obtained by bonding a 3 μm thick general electrolytic copper foil to a 35 μm thick copper carrier sheet were disposed on both the surfaces, one copper foil on each surface. The resultant set was laminate-molded under a vacuum of 30 mmHg or less for 2 hours at 110° C●30 minutes+200° C.●90 minutes and 5 kgf/cm²●20 minutes+20 kgf/cm²●100 minutes. The resultant board had an insulation layer thickness of almost 23 μm. The copper carrier sheets on the surfaces were removed. Each surface of the board was 1 shot irradiated directly with a carbon dioxide gas laser at an output of 13 mJ to make blind via holes having a diameter of 100 μm. After desmear treatment, electroless copper plating was adhered to form a layer having a thickness of 0.5 μm on each surface and electrolytic copper plating was adhered to form a layer having a thickness of 10 μm on each surface. Then, circuits were formed by a general method. Black copper oxide treatment was carried out and then the above-prepared heat-resistant film base-material-inserted B-staged resin composition sheets were similarly disposed with separating the release films, and the resultant set was similarly processed to produce a six-layered printed wiring board. Table 4 shows results of evaluation of this printed wiring board.

TABLE 4

| | Example 5-1 | Example 5-2 | Example 5-3 |
|---|---|---|---|
| Low-pressure plasma | Oxygen gas | Ar gas | Oxygen/Ar |
| treatment conditions | | | mixed gas |
| | 20 W · sec./ | 40 W · sec./ | 70 W · sec./cm² |
| | cm² | cm² | |
| | 0.20 Torr | 0.10 Torr | 10 Torr |
| Heat resistance in | | | |
| soldering after moisture | | | |
| absorption | | | |
| ∘PCT-0 hrs. | No swelling | No swelling | No swelling |
| ∘PCT-1 hrs. | No swelling | No swelling | No swelling |
| ∘PCT-3 hrs. | No swelling | No swelling | No swelling |
| Glass transition | 216 | 213 | 215 |
| temperature DMA (° C.) | | | |
| Thickness variance (μm) | 3.3 | 3.3 | 3.2 |
| Migration resistance in | | | |
| Z direction (Ω) | | | |
| Ordinary state | 6 × 10¹³ | 6 × 10¹³ | 6 × 10¹³ |
| 200 hrs. | 5 × 10¹¹ | 5 × 10¹¹ | 5 × 10¹¹ |
| 1,000 hrs. | 2 × 10¹¹ | 2 × 10¹¹ | 2 × 10¹¹ |

Example 6

500 parts of a bisphenol A type epoxy resin (trade name: Epikote 1001), 450 parts of a phenol novolak type epoxy resin (trade name: DEN438), 1 part of an imidazole type curing agent (trade name: 2E4MZ, supplied by Shikoku Corporation) and 30 parts of dicyandiamide were uniformly dispersed with a three-roll mill, to prepare a varnish. The above varnish was continuously applied to a 25 μm thick release PET film having a smooth surface and the applied varnish was dried, whereby B-staged resin composition sheets having a resin composition thickness of 20 μm and a gelation time of 68 seconds were obtained. The glass transition temperature, after curing, of this sheet was 160° C. Both surfaces of a 4.5 μm thick wholly aromatic polyamide film were plasma-treated under conditions shown in Table 5. The above B-staged resin composition sheets were disposed on both the surfaces of the polyamide film, one sheet on each surface, and these materials were continuously laminated with a heating roll at 100° C. under a linear load of 5 kgf/cm, whereby heat-resistant film base-material-inserted and release-film-adhered B-staged resin composition sheets were prepared. The heat-resistant film base-material-inserted and release-film-adhered B-staged resin composition sheet had an insulating layer thickness of almost 45 μm.

Separately, circuits of a copper survival rate of 30% were formed on an epoxy type copper-clad laminate having a thickness of 0.2 mm and having 18 μm thick copper foils on both surfaces (trade name: CCL-EL170, supplied by Mitsubishi Gas Chemical Company, INC.) and then conductors were treated to form black copper oxide, whereby internal layer boards were prepared. The above heat-resistant filmbase-material-inserted and release-film-adhered B-staged resin composition sheets were disposed on both surfaces of the internal layer board, one sheet on each surface, such that the resin layers faced to the internal layer board side. These materials were laminated at 100° C. at a linear load of 5 kgf/cm, to produce a double-side sheet-adhered substrate. Further, the above heat-resistant film-base-material-inserted and release film-adhered B-staged resin composition sheet was similarly bonded to one surface of the internal layer board, to prepare a single-side sheet-adhered substrate. The release PET films of these two kinds of substrates were separated. The double-side sheet-adhered substrate was disposed on a surface of the single-side sheet-adhered substrate which surface was opposite to the sheet-adhered surface. General electrolytic copper foils having a thickness of 12 μm were disposed on both surfaces of the set of the two kinds of the substrates. These materials were laminate-molded under a vacuum of 30 mmHg or less for 2 hours at 110° C.∘30 minutes+180° C∘90 minutes and 5 kgf/cm²∘15 minutes+20 kgf/cm²∘105 minutes, to prepare a six-layered board. Then, a printed wiring board was prepared by a conventional method. The thickness of the insulating layer between the internal layers was about 20 μm. Table 5 shows results of evaluation of this printed wiring board.

TABLE 5

| | Example 6-1 | Example 6-2 | Example 6-3 |
|---|---|---|---|
| Low-pressure plasma | Oxygen gas | Ar gas | Oxygen/Ar |
| treatment conditions | | | mixed gas |
| | 70 W · sec./ | 50 W · sec./ | 70 W · sec./cm² |
| | cm² | cm² | |
| | 0.10 Torr | 0.10 Torr | 0.10 Torr |
| Heat resistance in | | | |
| soldering after moisture | | | |
| absorption | | | |
| ∘PCT-0 hrs. | No swelling | No swelling | No swelling |
| ∘PCT-1 hrs. | No swelling | No swelling | No swelling |
| ∘PCT-3 hrs. | Swelling | Swelling | Swelling |
| | occurred | occurred | occurred |
| Glass transition | 165 | 165 | 165 |
| temperature DMA (° C.) | | | |
| Thickness variance (μm) | 5.7 | 5.2 | 5.5 |
| Migration resistance in | | | |
| Z direction (Ω) | | | |
| Ordinary state | 5 × 10¹³ | 5 × 10¹³ | 5 × 10¹³ |
| 200 hrs. | 5 × 10¹⁰ | 5 × 10¹⁰ | 5 × 10¹⁰ |
| 1,000 hrs. | 8 × 10⁹ | 8 × 10⁹ | 8 × 10⁹ |

### Comparative Example 5

In Example 6, the surfaces of the wholly aromatic polyamide film were treated in conditions shown in Table 6 and a heat-resistant base-material-inserted B-staged resin composition sheet was similarly produced. A six-layered printed wiring board was similarly produced. Table 6 shows evaluation results thereof.

TABLE 6

| | Comparative | Comparative | Comparative |
|---|---|---|---|
| | Example 5-1 | Example 5-2 | Example 5-3 |
| Low-pressure plasma | Oxygen gas | Ar gas | Oxygen/Ar |
| treatment conditions | | | mixed gas |
| | 0.1 W · sec./ | 5 W · sec./ | 50 W · sec./cm² |
| | cm² | cm² | |
| | 0.10 Torr | 760 Torr | 500 Torr |
| Heat resistance in | | | |
| soldering after moisture | | | |
| absorption | | | |
| ●PCT-0 hrs. | No swelling | No swelling | No swelling |
| ●PCT-1 hrs. | Swelling | Swelling | Swelling |
| | occurred | occurred | occurred |
| ●PCT-3 hrs. | Swelling | Swelling | Swelling |
| | occurred | occurred | occurred |
| Glass transition | 165 | 165 | 165 |
| temperature DMA (° C.) | | | |
| Thickness variance (μm) | 5.4 | 5.3 | 5.0 |

### Comparative Example 6

In Example 4, the thickness of the B-staged resin layer adhered to the roughness of the copper foil was changed to 30 μm from the tip of a convex portion, to prepare a metal-foil-adhered B-staged resin composition sheet. A laminate-molding curing treatment was similarly carried out by using only the above metal-foil-adhered B-staged resin composition sheet without using the heat-resistant film base material used in Example 4. A roughening treatment was similarly carried out, whereby almost the same total roughness from the external layer as that in Example 4 was obtained. A multilayer printed wiring board having six layers was similarly produced. Table 7 shows evaluation results thereof.

TABLE 7

| | Comparative |
|---|---|
| | Example 6 |
| Copper adhesive strength | 1.08 |
| (kgf/cm) | |
| Heat resistance in | |
| soldering after moisture | |
| absorption | |
| ●PCT-0 hrs. | No swelling |
| ●PCT-1 hrs. | No swelling |
| ●PCT-3 hrs. | No swelling |
| Glass transition | 192 |
| temperature DMA (° C.) | |
| Elastic modulus 25° C. | 995 |
| (kgf/mm²) | |
| Warp ● distortion (mm) | 5.3 |
| Thickness variance (μm) | 6.5 |
| Migration resistance in | |
| Z direction (Ω) | |
| Ordinary state | 5 × 10¹³ |
| 200 hrs. | 6 × 10¹⁰ |
| 1,000 hrs. | <10⁸ |

<Measurement Method>

1) Heat resistance in soldering after moisture absorption: A six-layered printed wiring board was subjected to a moisture absorption treatment under an ordinary state or with a pressure cooker testing machine. Then, the printed wiring board was immersed in solder at 260° C. for 30 seconds and then checked for failure.

PCT-0 hrs. : It shows an ordinary state. A pressure cooker test was not carried out.

PCT-1 hrs. :A treatment was carried out with a pressure cooker testing machine at 121° C./203 kPa for 1 hour.

PCT-3 hrs. :A treatment was carried out with a pressure cooker testing machine at 121° C./203 kPa for 3 hours.

### Comparative Example 7

In Example 5, 400 parts of a liquid epoxidized polybutadiene resin (tradename: E-1000-8.0, supplied by NIPPON PETROCHEMICALS CO., LTD) was added to the varnish obtained in Example 5, and the mixture was homogeneously stirred to obtain a varnish. This varnish was applied and dried similarly to Example 5, to obtain a release-film-adhered B-staged resin composition sheet. The glass transition temperature, after curing, of the sheet was less than 170° C. Both surfaces of a 4.5 μm thick wholly aromatic polyamide film were plasma-treated under conditions shown in Table 8. A heat-resistant base-material-inserted B-staged resin composition sheet was prepared similarly to Example 5, and a six-layered printed wiring board was produced. Table 8 shows evaluation results thereof.

TABLE 8

| | Comparative | Comparative | Comparative |
|---|---|---|---|
| | Example 7-1 | Example 7-2 | Example 7-3 |
| Plasma Treatment | Oxygen gas | Ar gas | Oxygen/Ar |
| conditions | | | mixed gas |
| | 20 W · sec./ | 40 W · sec./ | 70 W · sec./cm² |
| | cm² | cm² | |
| | 0.20 Torr | 0.10 Torr | 10 Torr |
| Heat resistance in | | | |
| soldering after moisture | | | |
| absorption | | | |
| ●PCT-0 hrs. | No swelling | No swelling | No swelling |
| ●PCT-1 hrs. | Swelling | Swelling | Swelling |
| | occurred | occurred | occurred |
| ●PCT-3 hrs. | Swelling | Swelling | Swelling |
| | occurred | occurred | occurred |
| Glass transition | Less than | Less than | Less than |
| temperature DMA (° C.) | 170° C. | 170° C. | 170° C. |

### Example 7

400 Parts of 2,2-bis(4-cyanatophenyl)propane monomer was melted at 150° C. and allowed to react for 4 hours with stirring, to prepare a prepolymer having an average molecular weight of 1,900. The prepolymer was dissolved in methyl ethyl ketone, to prepare a solution. To the solution were added, as epoxy resins liquid at room temperature, 100 parts of a bisphenol A type epoxy resin (trade name: Epikote 828, supplied by Japan epoxy resin), 50 parts of a bisphenol F type epoxy resin (trade name: EXA830LVP, supplied by Dainippon Ink And Chemicals, Incorporated), 50 parts of a novolak type epoxy resin (trade name: DEN438, supplied by Dow Chemical) and 400 parts of a bisphenol A type epoxy resin (trade name: Epikote 1001 supplied by Japan epoxy resin). 0.3 part of zinc octylate dissolved in methyl ethyl ketone was added as a heat-curing catalyst. The mixture was stirred and mixed to prepare a homogeneous varnish.

The above varnish was continuously applied to a mat surface of a copper foil having a thickness of 18 μm and dried to form a B-staged resin composition layer (gelation time at 170° C.: 55 seconds) having a thickness of 6 μm. At the time when the copper foil with the B-staged resin layer thereon came out from a drying zone, a protective polypropylene film having a thickness of 20 μm was disposed on the resin composition surface. These materials were laminated at 100° C. at a linear load of 4 kgf/cm to prepare a copper-foil-adhered B-staged resin composition sheet. Further, the above varnish was continuously applied to one surface of a 25 μm thick release PET film, and the applied varnish was dried to obtain a B-staged resin layer having a gelation time of 60 seconds and a thickness of 20 μm. At the time when the resultant film came out from a drying zone, a 20 μm thick polypropylene protective film was placed on the resin layer surface. These materials were laminated at 100° C. under a linear load of 4 kgf/cm, to prepare a release film-adhered B-staged resin composition sheet. This sheet was disposed on one surface of a 4.5 μm thick wholly aromatic polyamide film, whose both surfaces had been treated at 500 W for 7 minutes and had a contact angle of 10 degree or less with water, while separating the protective film. The above-obtained copper-foil-adhered B-staged resin composition sheet was disposed on the other surface of the wholly aromatic polyamide film while separating the protective film. These materials were continuously laminated at 90° C. at a linear load of 7 kgf/cm to integrate them, and the integrated material was wound up, whereby heat-resistant film base-material-inserted and copper-foil-adhered B-staged resin composition sheets were produced. The insulating layer thickness thereof was 30 μm from the tip of a copper foil convex portion.

Separately, circuits were formed on a BT resin copper-clad laminate (trade name: CCL-HL830, supplied by Mitsubishi Gas Chemical Company, INC.) which had an insulating layer thickness of 0.2 mm, had 12 μm thick copper foils on both surfaces and had a work size of 500×500 mm and then the copper foils were treated to form black copper oxide, whereby an internal layer board was prepared. The above heat-resistant film base-material-inserted and copper-foil-adhered B-staged resin composition sheet was disposed on each surface of the internal layer board with separating the PET film continuously such that the resin layer surface faced to the internal layer board. These B-staged resin composition sheets were temporally bonded to the internal layer board by laminating at 80° C. at a linear load of 4 kgf/cm, and, at the same time, these materials were preheated. Further, the set of these materials was continuously fed to a press machine having upper and lower smooth hot plates heated up to 150° C. in advance, and then a vacuum degree was increased up to 30 mmHg or less. Then, it was laminate-molded for 45 seconds to semi-cure it, whereby a laminate was obtained. Then, the obtained laminate was cut to obtain 30 boards having a predetermined size. These 30 boards were stacked. The stacked boards were placed in a heating furnace and then post-cured at 200° C. for 90 minutes to cure them, whereby copper-clad four-layered boards were obtained. Circuits were formed on the copper-clad four-layered board by a general method to obtain a printed wiring board. Table 9 shows evaluation results.

### Example 8

400 Parts of 2,2-bis(4-cyanatophenyl) ether monomer was melted at 150° C. and allowed to react for 4 hours with stirring, to prepare a prepolymer having an average molecular weight of 1,900. The prepolymer was dissolved in methyl ethyl ketone. To the resultant solution were added 100 parts of a bisphenol A type epoxy resin (trade name: Epikote 828), 150 parts of a bisphenol F type epoxy resin (trade name: EXA830LVP), 150 parts of a novolak type epoxy resin (trade name: DEN438) and 200 parts of a cresol novolak type epoxy resin (trade name: ESCN220F, supplied by Sumitomo Chemical Co., Ltd.) as epoxy resins liquid at room temperature. As a heat-curing catalyst, 0.3 part of iron acetylacetonate dissolved in methyl ethyl ketone was added thereto. 400 parts of talc (average particle diameter 1.8 μm, maximum particle diameter 4.2 μm) was added to the resultant mixture, and these materials were homogeneously stirred and mixed, to prepare a homogeneous varnish. The above varnish was continuously applied to one surface of a 25 μm thick release PET film having a smooth surface, and the applied varnish was dried to obtain a B-staged resin layer having a gelation time of 60 seconds and a thickness of 18 μm. At the time when the release PET film with the B-staged resin layer came out, it was disposed on each surface of a 4.5 μm wholly aromatic polyamide film whose both surfaces had been treated at 900 W for 2 minutes and had a water contact angle of 10 degree or less, and these materials were laminated with a roll at 100° C. at a linear load of 4 kgf/cm, whereby a heat-resistant film base-material-inserted B-staged resin composition sheets having a total thickness of about 40 μm was produced.

Separately, a circuit of a copper survival rate of 30% was formed on one surface of a BT resin copper-clad laminate having an insulating layer thickness of 0.2 mm and having 18 μm thick copper foils on both surfaces (trade name: CCL-HL830, supplied by Mitsubishi Gas Chemical Company, INC.) and then the circuit was treated to form black copper oxide, whereby two laminates having a circuit were prepared. The above heat-resistant film base-material-inserted B-staged resin composition sheet was temporally bonded to one of the two laminates by laminating similarly to Example 7, the release film was separated, and the other of the two laminates was disposed. The resultant set was placed in a press machine having hot plates heated up to 170° C. in advance. When a vacuum degree reached to 10 mmHg, it was pressed at a pressure of 40 kgf/cm² for 120 seconds, to obtain a semi-cured laminate. Then, the obtained laminate was cut to obtain 20 boards having a predetermined size. The 20 boards were stacked, and the stacked boards were post-cured at 200° C. for 90 minutes with supplying nitrogen to cure them, whereby copper-clad four-layered boards were obtained. A circuit was formed on the copper-clad four-layered board to obtain a printed wiring board. Table 9 shows evaluation results.

### Example 9

500 parts of a bisphenol A type epoxy resin (trade name: Epikote 1001), 450 parts of a phenol novolak type epoxy resin (trade name: DEN438), 30 parts of an imidazole type curing agent (trade name: 2E4MZ, supplied by Shikoku Corporation) and 400 parts of talc (average particle diameter 1.8 μm, maximum particle diameter 4.2 μm) were uniformly dispersed with a three-roll mill, to prepare a varnish. The above varnish was continuously applied to a 25 μm thick release PET film having a smooth surface and the applied varnish was dried, whereby B-staged resin composition sheets having a resin composition thickness of 15 μm and a gelation time of 68 seconds were obtained. Both surfaces of a 12 μm thick polyimide film were plasma-treated at 900 W for 10 minutes such that both the surfaces had a water contact angle of 10 degree or less. The above B-staged resin composition sheets were disposed on both the surfaces of the polyamide film, one sheet on each surface, and these materials were continuously laminated with a heating roll at 100° C. under a linear load of 5 kgf/cm, whereby heat-resistant film base-material-inserted and release-film-adhered B-staged resin composition sheets were prepared. The heat-resistant film base-material-inserted and release-film-adhered B-staged resin composition sheet had an insulating layer thickness of almost 42 μm.

Separately, circuits of a copper survival rate of 50% were formed on an epoxy type copper-clad laminate having a thickness of 0.2 mm and having 18 μm thick copper foils on both surfaces (trade name: CCL-EL170, supplied by Mitsubishi Gas Chemical Company, INC.) and then conductors were treated to form black copper oxide, whereby internal layer boards were prepared. The above heat-resistant film base-material-inserted and release-film-adhered B-staged resin composition sheets were disposed on both surfaces of the internal layer board, one sheet on each surface, such that the resin layers faced to the internal layer board side. These materials were laminated at 100° C. at a linear load of 5 kgf/cm while feeding these materials continuously. The obtained lamination material was continuously fed into a press machine while disposing copper foils on upper and lower surfaces of the lamination material, and these materials were laminate-molded at 150° C. at a vacuum degree of 30 mmHg or less for 50 seconds to carry out semi-curing, whereby a laminate was obtained. Then, the obtained laminate was cut to obtain 40 boards having a predetermined size. The 40 boards were stacked. The stacked boards were placed in a heating furnace and post-cured at 180° C. for 90 minutes to cure them. The cured board was similarly used to obtain a printed wiring board. Table 9 shows evaluation results.

TABLE 9

| | Examples | | |
|---|---|---|---|
| Item | 7 | 8 | 9 |
| Void | Nil | Nil | Nil |
| Heat resistance in | No failure | No failure | No failure |
| soldering after moisture | | | |
| absorption | | | |
| Glass transition | 196 | 213 | 160 |
| temperature DMA (° C.) | | | |
| Elastic modulus 25° C. | 1,611 | — | 1,577 |
| (kgf/mm²) | | | |
| Warp ∘ distortion (mm) | 1.2 | 1.0 | 1.3 |
| Thickness variance (μm) | 3.1 | 3.7 | 4.1 |
| Migration resistance in | | | |
| Z direction (Ω) | | | |
| Ordinary state | 6 × 10¹³ | 5 × 10¹³ | 4 × 10¹³ |
| 200 hrs. | 5 × 10¹¹ | 7 × 10¹¹ | 4 × 10¹¹ |
| 1,000 hrs. | 3 × 10¹⁰ | 4 × 10¹⁰ | 1 × 10¹⁰ |

### Example 10

400 Parts of 2,2-bis(4-cyanatophenyl)propane monomer was melted at 150° C. and allowed to react for 4 hours with stirring, to prepare a prepolymer having an average molecular weight of 1,900. The prepolymer was dissolved in methyl ethyl ketone, to prepare a solution. To the solution were added 100 parts of a bisphenol A type epoxy resin (trade name: Epikote 828, supplied by Japan epoxy resin), 400 parts of a bisphenol A type epoxy resin (trade name: Epikote 1001 supplied by Japan epoxy resin), 50 parts of a bisphenol F type epoxy resin (trade name: EXA830LVP, supplied by Dainippon Ink And Chemicals, Incorporated) and 50 parts of a phenol novolak type epoxy resin (trade name: DEN438, supplied by Dow Chemical). 0.3 part of zinc octylate dissolved in methyl ethyl ketone was added and these materials were mixed to obtain a mixture solution. 100 parts of an epoxidized polybutadiene resin (trade name: E-1000-8.0, supplied by NIPPON PETROCHEMICALS CO., LTD) and 30 parts of an epoxy-group-modified acryl multilayer structure powder (trade name: STAPHYLOID IM-203, average particle diameter 0.2 μm, supplied by Ganz Chemical Co., Ltd.) were added to the mixture solution, and these materials were mixed to prepare a varnish. The above mixture solution was continuously applied to one surface of a 25 μm thick release PET film, and the applied varnish was dried to form a B-staged resin layer having a resin composition thickness of 20 μm (gelation time at 170° C.: 67 seconds). At the time when the resultant film came out from a drying zone, a 20 μm thick polypropylene protective film was placed on the resin layer surface. These materials were laminated at 100° C. under a linear load of 4 kgf/cm, to prepare a release film-adhered B-staged resin composition sheet. The above varnish was continuously applied to a mat surface (roughness 3.0 to 5.9 μm, average roughness Rz: 4.6 μm) of a copper foil having a thickness of 18 μm and dried, to form a B-staged resin composition layer (gelation time at 170° C.: 48 seconds) which had a thickness, from the tip of the maximum convex portion of the copper foil, of 5.5 μm. When the copper foil with the B-staged resin layer thereon came out from a drying zone, a polypropylene protective film having a thickness of 20 μm was disposed on the resin composition surface. These materials were laminated at 100° C. at a linear load of 4 kgf/cm to prepare a copper-foil-adhered B-staged resin composition sheet. A 4.5 μm thick wholly aromatic polyamide film was surface-treated by a physical treatment and a low pressure plasma-treatment shown in Table 10. Then, the above release film-adhered B-staged resin composition sheet was disposed on one surface of the wholly aromatic polyamide film with separating the protective film, the above-obtained copper-foil-adhered B-staged resin composition sheet was disposed on the other surface of the wholly aromatic polyamide film with separating the protective film, and these materials were continuously laminated at 90° C. at a linear load of 7 kgf/cm to integrate them, whereby heat-resistant film base-material-inserted and copper-foil-adhered B-staged resin composition sheets were produced. The insulating layer thickness thereof was 30 μm from the tip of a copper foil convex portion.

Separately, circuits of a copper survival rate of 30% were formed on a copper-clad laminate having a thickness of 0.2 mm and having 12 μm thick copper foils on both surfaces (trade name: CCL-HL830, supplied by Mitsubishi Gas Chemical Company, INC.) and then the copper foils were treated to form black copper oxide, where by an internal layer board was prepared. The above heat-resistant film base-material-inserted and copper-foil-adhered B-staged resin composition sheets were disposed on both surfaces of the internal layer board with separating the release PET films such that the resin layer surfaces faced to the internal layer board. The resultant set was placed in a press machine and temperature-increased from room temperature to 170° C. over 25 minutes, and the above set was maintained at a pressure of 15 kgf/cm² at 170° C. for 30 minutes at a vacuum degree of 3 mmHg or less. Then, it was cooled and taken out, to obtain a multilayer board. The copper foils on the external surfaces of the multilayer board were removed by etching. Then, the resultant surfaces were 1-shot irradiated with a carbon dioxide gas laser at an output of 10 mJ to make blind via holes having a diameter of 95 μm each. The multilayer board was immersed in a potassium permanganate type desmear solution (Nippon MacDermid Co., Inc.) to carry out swelling and desmearing (dissolution). Then, neutralization was carried out, to make roughened surfaces having a total external layer roughness of 3.8 to 6.0 μm (average roughness Rz: 5.1 μm) each. At the same time, the resin remaining in the bottom of each blind via hole was dissolved and removed. Then, the roughened surfaces were plated to form an electroless copper plating layer having a thickness of 0.5 μm on each surface and plated to form an electrolytic copper plating layer having a thickness of 20 μm on each surface. The multilayer board was placed in a heating furnace, gradually temperature-increased from 100° C. to 150° C. over 30 minutes, further gradually temperature-increased to 190° C. and cured under heat at 190° C. for 60 minutes, to obtain a four-layered board. Copper conductor circuits were formed on both surfaces of the four-layered board according to the semi-additive process, and the conductor circuit surfaces were subjected to black copper oxide treatment, to obtain an internal layer board. The same steps as those carried out after the above laminate-molding were carried out to produce a six-layered board. Table 10 shows evaluation results.

### Example 11

400 Parts of 2,2-bis(4-cyanatophenyl)ether monomer was melted at 150° C. and allowed to react for 4 hours with stirring, to prepare a prepolymer having an average molecular weight of 1,900. The prepolymer was dissolved in methyl ethyl ketone, to obtain a solution. To the solution were added 100 parts of a bisphenol A type epoxy resin (trade name: Epikote 828), 150 parts of a bisphenol F type epoxy resin (trade name: EXA830LVP), 150 parts of a phenol novolak type epoxy resin (trade name: DEN438) and200 parts of a cresol novolak type epoxy resin (trade name: ESCN220F, supplied by Sumitomo Chemical Co., Ltd.). 0.3 part of iron acetylacetonate dissolved in methyl ethyl ketone was added to the resultant mixture, and these materials were mixed, to prepare a mixture solution.

The above mixture solution was continuously applied to one surface of a 25 μm thick release PET film having a smooth surface, the applied varnish was dried to obtain a B-staged resin layer (gelation time at 170° C.: 60 seconds) having a resin composition thickness of 18 μm, a 20 μm thick polyethylene protective film was attached to the resin layer surface at the time when the resultant film with the B-staged resin layer came out from a drying zone, and these materials were integrated, whereby a sheet having a resin composition layer thickness of 18 μm was obtained. Further, the above mixture solution was continuously applied to one surface of a 25 μm thick release PET film having a smooth surface, the applied varnish was dried to obtain a B-staged resin layer (gelation time at 170° C.: 64 seconds) having a resin composition thickness of 5 μm, a 20 μm thick polyethylene protective film was attached to the resin layer surface at the time when the resultant film with the B-staged resin layer came out from a drying zone, and these materials were integrated, whereby a sheet having a resin composition layer thickness of 5 μm was obtained. A 12 μm thick polyimide film was surface-treated by a surface treatment and a plasma-treatment under conditions shown in Table 10. Two kinds of the above sheets were disposed on both surfaces of the polyimide film, one sheet on one surface, with separating the polyethylene protective films, and these materials were continuously laminated at 100° C. under a linear load of 4 kgf/cm, whereby heat-resistant film base-material-inserted B-staged resin composition sheets having a total thickness of 35 μm each were prepared.

Separately, circuits of a copper survival rate of 30% were formed on a copper-clad laminate having a thickness of 0.2 mm and having 18 μm thick copper foils on both surfaces (trade name: CCL-HL830) and then the copper foils were treated to form black copper oxide, whereby an internal layer board was prepared. The above heat-resistant film base-material-inserted B-staged resin composition sheet was disposed on each surface of the internal layer board such that the resin layer having a thickness of 18 μm faced to the internal layer board side. These B-staged resin composition sheets were laminate-bonded to the internal layer board at 100° C. at a linear load of 5 kgf/cm, and then the release PET films on the external layers were peeled off. Copper foils (trade name: Super Thin foil, supplied by Mitsui Mining and Smelting Co., Ltd.) obtained by bonding a 3 μm thick electrolytic copper foil to a 35 μm thick copper carrier sheet were disposed on both the surfaces, one copper foil on each surface. The resultant set was laminate-molded under a vacuum degree of 30 mmHg or less for 2 hours at 110° C./30 minutes+200° C./90 minutes and 5 kgf/cm²/20 minutes+20 kgf/cm²/100 minutes, to obtain a multilayer board. The multilayer board had an insulation layer thickness of almost 23 μm. The copper carrier sheets on the surfaces of the multilayer board were removed. Each surface of the board was 1 shot irradiated directly with a carbon dioxide gas laser at an output of 13 mJ to make blind via holes having a diameter of 100 μm. After desmear treatment, electroless copper plating was adhered to form a layer having a thickness of 0.5 μm on each surface and electrolytic copper plating was adhered to form a layer having a thickness of 10 μm on each surface. Then, circuits were formed by a general method, and black copper oxide treatment was carried out, to obtain an internal layer board. The same steps as those carried out after the above laminate-molding were carried out to produce a six-layered board. Table 10 shows evaluation results.

### Example 12

500 parts of a bisphenol A type epoxy resin (trade name: Epikote 1001), 450 parts of a phenol novolak type epoxy resin (trade name: DEN438), 1 part of an imidazole type curing agent (trade name: 2E4MZ, supplied by Shikoku Corporation) and 30 parts of dicyandiamide were mixed, to prepare a varnish. The above varnish was continuously applied to one surface of a 25 μm thick release PET film having a smooth surface and the applied varnish was dried, whereby sheets having a B-staged resin composition layer having a resin composition thickness of 20 μm (gelation time at 170° C.: 68 seconds) were obtained. A 4.5 μm thick wholly aromatic polyamide film was surface-treated by a physical treatment and a plasma-treatment under conditions shown in Table 10. The above sheets were disposed on both surfaces of the polyamide film, one sheet on each surface, and these materials were continuously laminated with a heating roll at 100° C. under a linear load of 5 kgf/cm, whereby heat-resistant film base-material-inserted and release-film-adhered B-staged resin composition sheets were prepared. The heat-resistant film base-material-inserted and release-film-adhered B-staged resin composition sheet had an insulating layer thickness of almost 45 μm.

Separately, circuits of a copper survival rate of 30% were formed on a copper-clad laminate having a thickness of 0.2 mm and having 18 μm thick copper foils on both surfaces (trade name: CCL-EL170, supplied by Mitsubishi Gas Chemical Company, INC.) and then conductors were treated to form black copper oxide, whereby internal layer boards were prepared. The above heat-resistant film base-material-inserted and release-film-adhered B-staged resin composition sheet was disposed on each surface of the internal layer board with separating the release PET film on one surface of the B-staged resin composition sheet. These materials were laminated at 100° C. at a linear load of 5 kgf/cm, to produce a double-side sheet-adhered substrate. Further, the above heat-resistant film base-material-inserted and release film-adhered B-staged resin composition sheet was disposed on one surface of the internal layer board with separating the release PET film on one surface of the B-staged resin composition sheet, and these materials were similarly laminated, to prepare a single-side sheet-adhered substrate. The release PET films of these two kinds of substrates were separated. The double-side sheet-adhered substrate was disposed on a surface of the single-side sheet-adhered substrate which surface was opposite to the B-staged-resin-composition-sheet-adhered surface. Electrolytic copper foils having a thickness of 12 μm were disposed on both surfaces of the set of the two kinds of the substrates. The resultant set was laminate-molded under a vacuum of 30 mmHg or less for 2 hours at 110° C./30 minutes+180° C./90 minutes and 5 kgf/cm²/15 minutes+20 kgf/cm²/100 minutes, to prepare a six-layered board. The thickness of the insulating layer between the internal layers was about 20 μm. Table 10 shows evaluation results.

### Comparative Examples 8 and 9

Six-layered boards were obtained in the same manner as in Example 12 except that the surfaces of the wholly aromatic polyamide film were treated under conditions shown in Table 11. Table 11 shows evaluation results.

### Comparative Example 10

A six-layered board was obtained in the same manner as in Example 10 except that a B-staged resin composition layer having a thickness, from the tip of the maximum convex portion of the copper foil, of 30 μm was formed in place of the B-staged resin composition layer having a thickness of 5.5 μm from the tip of the maximum convex portion, to prepare a copper-foil-adhered B-staged resin composition sheet, and that only the above copper-foil-adhered B-staged resin composition sheet was used without the heat-resistant film base material used in Example 10. Table 11 shows evaluation results.

TABLE 10

| | Example 10 | Example 11 | Example 12 |
|---|---|---|---|
| Physical treatment | Buff | Sandblasting | Wet blasting |
| | polishing | | |
| Low-pressure Plasma | Oxygen gas | He gas | Nitrogen gas |
| Treatment conditions | 20 W · sec./ | 30 W · sec./ | 3 W · sec./cm² |
| | cm² | cm² | |
| | 0.1 Torr | 0.5 Torr | 5.1 Torr |
| Heat resistance after | | | |
| moisture absorption | | | |
| ●PCT-1 hrs. | No failure | No failure | No failure |
| ●PCT-3 hrs. | No failure | No failure | No failure |
| Thickness variance (μm) | 3.0 | 3.1 | 5.2 |
| Migration resistance (Ω) | | | |
| 200 hrs. | 6 × 10¹¹ | 8 × 10¹¹ | 5 × 10¹⁰ |
| 1,000 hrs. | 3 × 10¹⁰ | 2 × 10¹¹ | 8 × 10⁹ |

TABLE 11

| | Comparative | Comparative | Comparative |
|---|---|---|---|
| | Example 8 | Example 9 | Example 10 |
| Physical treatment | Wet blasting | Nil | — |
| Low-pressure Plasma | Nil | Nitrogen gas | — |
| Treatment conditions | | 3 W · sec./cm² | |
| | | 5.1 Torr | |
| Heat resistance after | | | |
| moisture absorption | | | |
| ●PCT-1 hrs. | Swelling | No failure | No failure |
| | occurred | | |
| ●PCT-3 hrs. | Swelling | Swelling | No failure |
| | occurred | occurred | |
| Thickness variance (μm) | 5.2 | 5.2 | 6.5 |
| Migration resistance (Ω) | | | |
| 200 hrs. | 5 × 10¹⁰ | 5 × 10¹⁰ | 6 × 10¹⁰ |
| 1,000 hrs. | 8 × 10⁹ | 8 × 10⁹ | <10⁸ |

<Measurement methods>

Heat resistance after moisture absorption: After a treatment using a pressure cooker testing machine at 121° C./203 kPa for 1 hour or 3 hours, a six-layered board was immersed in solder at 260° C. for 30 seconds and then checked for appearance failures by visual observation.

Thickness variance: A six-layered board was measured for an insulating layer thickness by using a cross-sectional photograph of the six-layered board (maximum value—minimum value).

Migration resistance: Copper foil portions having a size of 10×10 mm were left in the second layer and the third layer (the third layer and the fourth layer in Example 12 and Comparative Examples 11 and 12) of a six-layered board at the same positions, and 100 such copper foil portions were connected to prepare a specimen. The specimen was measured for insulating resistance in the insulating layer in the Z direction at 85° C.●85% RH under application of 100 VDC.

What is claimed is:

1. A heat-resistant film base-material-inserted B-staged resin composition sheet obtainable by adhering a layer of a B-staged resin composition to a heat-resistant film base material,
wherein the heat-resistant film base material is plasma-treated before adhering the B-staged resin composition layer.

2. The sheet according to claim 1,
wherein a metal foil adheres to one surface of the heat-resistant film base-material-inserted B-staged resin composition sheet.

3. The sheet according to claim 1,
wherein the heat-resistant film base material is a wholly aromatic polyamide film.

4. The sheet according to claim 1,
wherein the plasma-treatment is a low-pressure plasma treatment.

5. The sheet according to claim 1,
wherein the plasma-treated heat-resistant film has a surface having a contact angle of 50 degree of lower with water.

6. The sheet according to claim 1,
wherein the B-staged resin composition contains a component less-soluble in a roughening solution and a component soluble in the roughening solution.

7. The sheet according to claim 1,
wherein the plasma treatment is carried out by a surface treatment at a treatment electric power of 10 to 80 W·sec/cm².

8. The sheet according to claim 1,
wherein the resin composition of the B-staged resin composition sheet is a polyfunctional cyanate ester resin composition.

9. The sheet according to claim 1,
wherein the resin composition of the B-staged resin composition sheet is a thermosetting resin composition whose glass transition temperature after curing is at least 180° C.

10. The sheet according to claim 1,
wherein the heat-resistant film is preliminarily surface-treated by physical treatment other than the plasma treatment before the plasma treatment.

11. A multilayer board using the heat-resistant film base-material-inserted B-staged resin composition sheet recited in claim 1 in a buildup layer and/or a bonding layer.

12. A manufacturing process of a multilayer board, which process comprising preparing a disposition material in which the heat-resistant film base-material-inserted B-staged resin composition sheets recited in claim 1 are disposed on upper and lower surfaces of conductor circuit substrate(s) and/or between the conductor circuit substrate(s) and a metal foil is contained as an outermost layer, bonding the above components of the disposition material to each other with a flat and smooth heating plate under pressure to carry out semi-curing and then heating it in a heating furnace to carry out curing.

13. The process according to claim 12,
wherein the disposition material is preheated simultaneously with temporal-bonding of the components of the disposition material before inserting it into a heating furnace.

14. The process according to claim 12,
wherein the disposition material is continuously produced.

15. The process according to claim 12,
wherein the conductor circuit substrate(s) are preliminarily preheated.

16. The process according to claim 12,
wherein the bonding under pressure and semi-curing are carried out under vacuum.

17. The process according to claim 12,
wherein the bonding under pressure and semi-curing are continuously carried out.
